(19) United States
(12) Patent Application Publication
(10) Pub. No.: US 2016/0127465 A1
(43) Pub. Date: May 5, 2016

(54) CROSS-PLATFORM DATA SYNCHRONIZATION

(71) Applicant: Bedrock Data, Inc., Boston, MA (US)

(72) Inventors: Taylor BARSTOW, Cambridge, MA (US); Benjamin Adam SMITH, Hingham, MA (US)

(21) Appl. No.: 14/928,303

(22) Filed: Oct. 30, 2015

Related U.S. Application Data
(60) Provisional application No. 62/073,411, filed on Oct. 31, 2014.

(51) Int. Cl. H04L 29/08; H04L 12/24; G06Q 30/00; G06F 17/30

(52) U.S. Cl. CPC H04L 67/1095; G06F 17/30575; H04L 41/5019; G06F 17/30371; G06Q 30/01

(57) ABSTRACT

Systems, apparatus, and methods are disclosed for using a deduplication index, a centralized cache repository, and a data mapping mechanism to detect and synchronize changes to deduplicated data objects stored in two or more third party databases. The disclosed systems, apparatus, and methods can maintain, in a deduplication index, a two-way mapping between one or more data object references and a datagram which uniquely identifies the real-world entity represented by said data object; maintain, in the centralized cache repository, two temporal states, one including current information, the other including previously-synchronized information. The disclosed systems, apparatus, and methods can also implement the data mapping mechanism to determine corresponding data objects in other systems when one or more data objects have apparent changes when compared with the centralized cache repository, and apply a given configuration in order to synchronize the current temporal states of all such data objects.

### CROSS-REFERENCE TO RELATED APPLICATIONS

This application claims benefit under 35 U.S.C. §119(e) of U.S. Provisional Patent Application No. 62/073,411, entitled “TECHNIQUES FOR AUTOMATED CROSS-PLATFORM DATA AND PROCESS SYNCHRONIZATION,” filed on Oct. 31, 2014, by Barstow, which is hereby incorporated herein by reference in its entirety.

### TECHNICAL FIELD

Disclosed apparatus, computerized systems, and computerized methods relate generally to cross-platform data synchronization for data management, database integration, and/or process centralization.

### BACKGROUND

The business constraint for managing the deduplication and synchronization of data across separate but related peer services has ballooned in recent years. Due to a proliferation of business-oriented software services, many companies utilize multiple such services, employing the “best tool for the job” in each respective area of responsibility. In such companies, many mission critical business processes such as selling, invoicing, and other processes are often split across two or more software systems, and the proper, timely functioning of these processes has direct impact on the bottom line. Unfortunately, the existing solutions for data synchronization are unable to deliver correct results with the efficiency, simplicity, low cost, reliability, and flexibility.

### SUMMARY

In accordance with the disclosed subject matter, apparatus, systems, non-transitory computer-readable media, and methods are provided for synchronizing data across platforms for data management, database integration, and/or process centralization.

Some embodiments include a system configured to synchronize data objects in a plurality of external systems. The system includes one or more interfaces configured to communicate with a client device. The system also includes at least one server, in communication with the one or more interfaces, configured to receive a request from a client device over via the one or more interfaces, wherein the request includes an instruction to configure a service level agreement (SLA) configuration, wherein the SLA configuration is configured to specify a policy for automatically synchronizing data between two or more external systems, receive a plurality of data objects from the plurality of external systems in compliance with the SLA configuration, and deduplicate the plurality of data objects to determine a set of deduplicated data objects from the plurality of data objects in compliance with the SLA configuration. The at least one server is also configured to determine one or more differences between the set of deduplicated data objects, and synchronize information between the set of deduplicated data objects by writing the one or more differences into the plurality of data objects stored in the plurality of external systems.

In some embodiments, the system includes a load balancer module that is configured to receive the external request and select a functioning server, in the system, for serving the external request.

In some embodiments, the at least one server is further configured to automatically synchronize information between the set of deduplicated data objects on a periodic basis.

In some embodiments, the at least one server comprises a single data center.

Some embodiments include a computerized method of synchronizing data objects in a plurality of external systems. The method includes receiving, by a system comprising at least one server, a request from a client device over via one or more interfaces, wherein the request includes an instruction to configure a service level agreement (SLA) configuration, wherein the SLA configuration is configured to specify a policy for automatically synchronizing data between two or more external systems. The method also includes receiving, by the system, a plurality of data objects from the plurality of external systems in compliance with the SLA configuration, deduplicating, by the system, the plurality of data objects to determine a set of deduplicated data objects from the plurality of data objects in compliance with the SLA configuration, determining, by the system, one or more differences between the set of deduplicated data objects, and synchronizing, by the system, information between the set of deduplicated data objects by writing the one or more differences into the plurality of data objects stored in the plurality of external systems.

In some embodiments, the method also includes automatically synchronizing information between the set of deduplicated data objects on a periodic basis.

Some embodiments include a non-transitory computer readable medium having executable instructions. The executable instructions are operable to cause a data processing apparatus to receive a request from a client device over via one or more interfaces, wherein the request includes an instruction to configure a service level agreement (SLA) configuration, wherein the SLA configuration is configured to specify a policy for automatically synchronizing data between two or more external systems. The executable instructions are also operable to cause the data processing to receive a plurality of data objects from a plurality of external systems in compliance with the SLA configuration, deduplicate the plurality of data objects to determine a set of deduplicated data objects from the plurality of data objects in compliance with the SLA configuration, determine one or more differences between the set of deduplicated data objects, and synchronize information between the set of deduplicated data objects by writing the one or more differences into the plurality of data objects stored in the plurality of external systems.

In some embodiments, the executable instructions are also operable to cause the data processing to automatically synchronize information between the set of deduplicated data objects on a periodic basis.

In some embodiments, the SLA configuration comprises a description of external systems between which to synchronize data objects.

In some embodiments, the SLA configuration further comprises a description of data objects, maintained by external systems satisfying the description of external systems, that are subject to synchronization.

In some embodiments, the SLA configuration further comprises a description of fields, in data objects satisfying the description of data objects, that are subject to synchronization.

In some embodiments, the external request comprises a stream of Hypertext Transfer Protocol (HTTP) requests.

In some embodiments, the plurality of external systems comprises a CRM system, a marketing automation system, and/or a finance system.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a business enterprise system in accordance with some embodiments.

FIG. 2 illustrates the context in which Virtual Data Integration Platform operates, including client devices, peers, and primary components in accordance with some embodiments.

FIG. 3 illustrates the server architecture of Platform in accordance with some embodiments.

FIG. 4 illustrates Database Services components in accordance with some embodiments.

FIG. 5 illustrates a listing of data components which can be stored by Document Database module in accordance with some embodiments.

FIG. 6 provides a visual representation of data stored by Search Database in accordance with some embodiments.

FIG. 7 shows data components provided within Key/Value Store module in accordance with some embodiments.

FIG. 8 illustrates the API Services components and their peers from a high level as they exist in accordance with some embodiments.

FIG. 9 illustrates a SLA Service module in accordance with some embodiments.

FIG. 10 shows a Record Cache Service module in accordance with some embodiments.

FIG. 11 illustrates a Normal Docs Service module in accordance with some embodiments.

FIG. 12 illustrates a Connectors Service module in accordance with some embodiments.

FIG. 13 illustrates a Transactions Service module and its sole sub-service Events in accordance with some embodiments.

FIG. 14 illustrates Management Interface in accordance with some embodiments.

FIG. 15 illustrates the components utilized in Accounts Application in accordance with some embodiments.

FIG. 16 shows the primary components of Static Runtime Bundle in accordance with some embodiments.

FIG. 17 provides a visual breakdown of Credentials Management Application in accordance with some embodiments.

FIG. 18 illustrates the Virtual Data Bus in accordance with some embodiments.

FIG. 19 illustrates the Difference Collector in accordance with some embodiments.

FIG. 20 illustrates the method steps implemented by the Record Matcher in accordance with some embodiments.

FIG. 21 shows the method steps implemented by the Data Mapper in accordance with some embodiments.

FIG. 22 shows the method steps implemented by Data Transmitter in accordance with some embodiments.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems and methods that are within the scope of the disclosed subject matter.

Modern Distributed Business Processes often involve multiple software systems, with each system providing capabilities in one particular area of focus (such as “sales”, “marketing”, and so forth). Distributed business processes often involve multiple software systems. Therefore, a mechanism for integrating data and processes across several such systems has become a key component of back office business data management. Thus the proper and timely functioning of synchronization is of crucial importance a business utilizing the shown system, and it is clearly in the interest of such a business to maximize the correctness, reliability, and efficiency of synchronization.

Traditionally, this need has been met with one of the following solutions: (i) a manual procedure whereby a human operator synchronizes data between systems by hand; (ii) a traditional Extract Transform Load (ETL) pipeline which extracts data from one system, transforms it to the format of another, and loads the transformed data into the latter system automatically; or (iii) a decentralized solution wherein a peer service is deployed to each of the systems to be synchronized, and where said peer services communicate with each other directly in order to keep data in the various associated systems synchronized.

While all of these solutions may move data from point A to point B, they have issues with data conflicts, meaning that some data cannot be synchronized in certain scenarios. In addition, the automated solutions (ii) and (iii) are difficult to change, often requiring additional software development in order to make modifications.

The disclosed apparatus, systems, and methods provide a Virtual Data Integration Platform which avoids these issues, providing a centralized, conflict-free, turn-key solution. The disclosed apparatus, systems, and methods also provide a Data Mapping Module, providing an automated mechanism of synchronizing data between individual sets of deduplicated data objects which may be stored across separate external systems (e.g., third party systems operated by third part vendors), while automatically resolving any data conflicts.

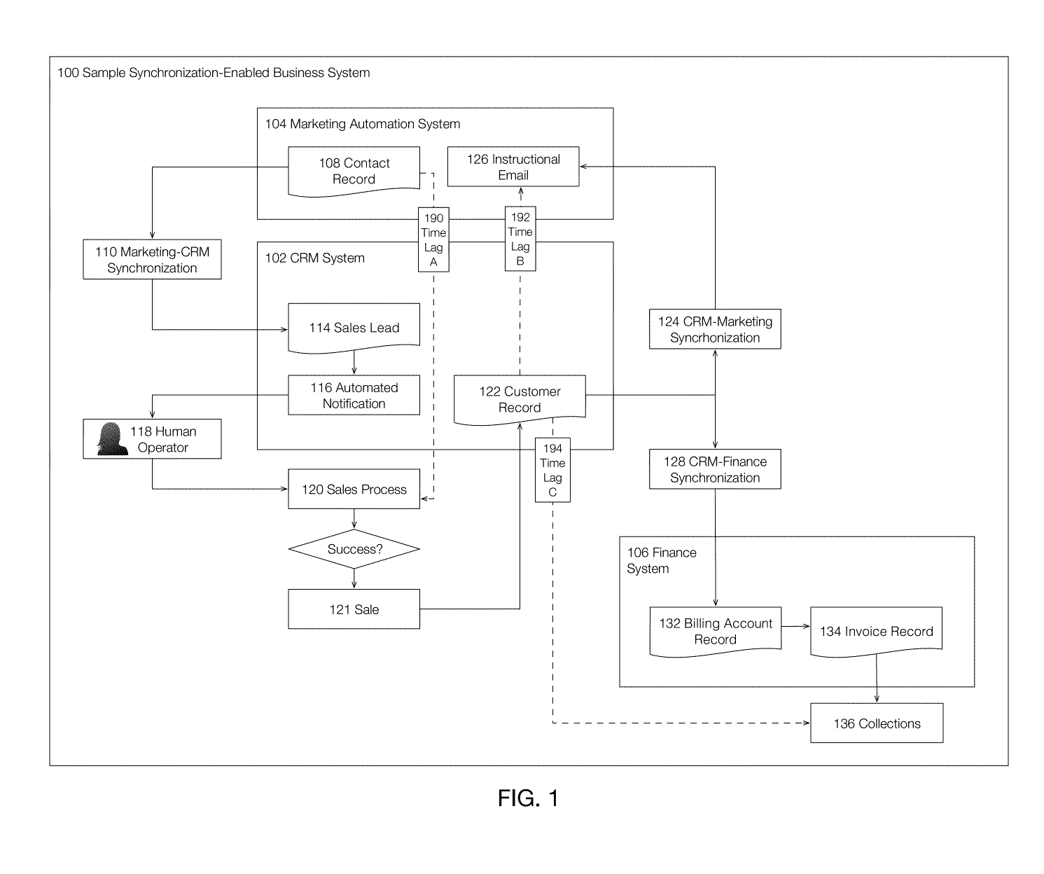

In some embodiments, the Virtual Data Integration Platform can rely on a Service Level Agreement (SLA) configuration, which is defined via a Management Interface which is provided by the Virtual Data Integration Platform. The SLA configuration can include a specification which describes a policy for automatically synchronizing data between two or more external systems, such as Third Party Systems. For example, FIG. 1 illustrates an example of such a synchronization process. The Service Level Agreement can codify a wide range of such data synchronization processes, such that the Platform may automatically apply the policies contained therein. The SLA configuration can include, for example, a list of systems to synchronize data between; a description of data objects in such systems that should be synchronized; a description of fields in said data objects that should be synchronized, and with what priority; a set of filters determining whether or not a particular data object should be synchronized; and additional details pertaining to automated data synchronization operations.

In some embodiments, these automated operations are executed by a Virtual Data Bus, which is configured to apply the User-defined Service Level Agreement configuration, such that the Platform may comply with said Agreement. The Virtual Data Bus can be configured to fetch data objects from external systems specified by the SLA configuration; detect changes to said data objects; deduplicate the data objects in order to find uniquely represented real-world entities; synchronize data between a set of deduplicated data objects; and/or report on said synchronization for purposes of troubleshooting and analysis. This is referred to as a “Virtual” Data Bus because the underlying infrastructure can be totally hidden from Users and can support multi-tenancy, such that a User may simply visit a website, register to join the Platform, define an SLA configuration using the Management Interface, and start synchronizing data immediately.

In some embodiments, the Virtual Data Integration Platform can be horizontally scalable, such that computing components may be added as needed to accommodate a growing User base, while individual Users are not impacted. This is in contrast to a more traditional Platform that would require some sort of install on hardware provisioned and managed by the User, or by a Third Party who has been contracted by said User, and would require ongoing maintenance of said infrastructure, again managed by said User.

In some embodiments, the Virtual Data Integration Platform can provide one or more performance guarantees about its data synchronization behaviors, such as: (i) correctness, meaning that the Virtual Data Bus will move data between the User's desired Third Party Systems exactly as specified by the SLA configuration; and (ii) safety, meaning that the Virtual Data Bus operates in a manner that is conflict-free, such that data synchronization can be fully automatic, never relying on the User to make a conflict resolution decision.

In some embodiments, the Virtual Data Integration Platform can also provide additional guarantees. For example, a security-focused implementation can guarantee data encryption at rest and a strict adherence to security principles when developing the software. As another example, a compliance-focused implementation can guarantee that all interaction with the System, including development, testing, deployment, and maintenance, is governed by clearly documented Standard Operating Procedures.

FIG. 1 shows a potential business management system in accordance with some embodiments. This system includes, as an example, three external systems: Customer Relationship Management (CRM) System 102, Marketing Automation System 104, and Finance System 106. These external systems are also sometimes referred to as third party systems, which in some embodiments can include a system which contains data that can be synchronized with other such systems via a communications network, including systems which have an ability to service automated remote procedure calls (via an API or other means) to read and write data, but also systems which may not have such a faculty, but which may able to transmit data in a different way, such as via an hourly or daily log of batched changes from said time period, or via other methods.

When Marketing Automation System 104 collects Contact Record 108, Marketing-CRM Synchronization module 110 automatically copies Contact Record 108 to CRM System 102, creating Sales Lead Record 114. This causes CRM System 102 to send Automated Notification 116 to Human Operator 118, allowing Human Operator 118 to begin Sales Process 120. If 120 is completed successfully, it results in Sale 121, and CRM System 102 automatically generates Customer Record 122. CRM-Marketing Synchronization 124 subsequently copies the changes to Marketing Automation System 104, which, in turn, sends Instructional Email 126 automatically. Simultaneously, CRM-Finance Synchronization 128 copies Customer Record 122 to Finance System 106, creating Billing Account Record 132. Once that occurs, Finance System 106 automatically generates Invoice 134, and Collections Module 136 sends said Invoice and ensures payment.

Marketing-CRM Synchronization module 110 can determine the length of Time Lag A 190, that is, the amount time elapsed between initial collection of Contact Record 108 and the start of Sales Process 120. The length of Time Lag A 190 can be inversely correlated to the probability of successful completion of Sales Process 120. In other words, as Time Lag A 190 shortens, new sales become more likely.

CRM-Marketing Synchronization module 124 determines the length of Time Lag B 192, that is, the time elapsed between successful completion of Sales Process 120 and distribution of Instructional Email 126 to the new user. Assume that the business utilizing the system provides a time-sensitive service, and historical data shows that the length of Time Lag B 192 is inversely correlated to the probability of future return business from the new user.

Finally, CRM-Finance Synchronization module 128 determines the length of Time Lag C 194—the time elapsed between successful completion of Sales Process 120 and initiation of Collections 136. Therefore, Lag C 194 determines the ability of a business utilizing the shown system to properly collect revenues.

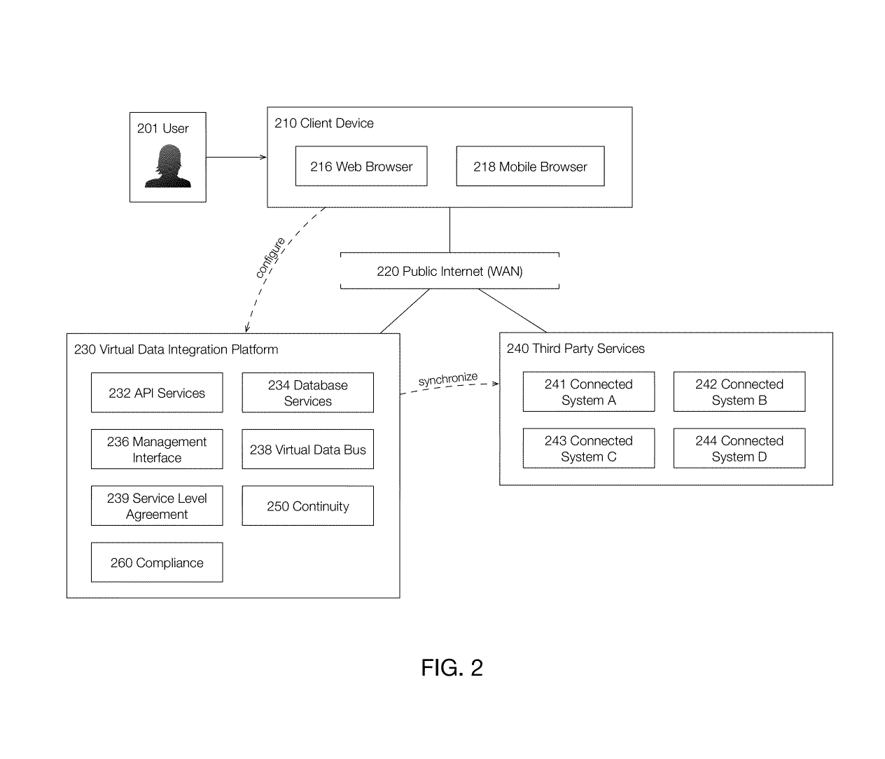

FIG. 2 illustrates the context in which Virtual Data Integration Platform 230 operates, including client devices, peers, and primary components in accordance with some embodiments. Client Device 210 can receive instructions from User 201 to access Virtual Management Interface 236 of Virtual Data Integration Platform 230, configuring a Service Level Agreement configuration 239 which governs automated operations performed continuously by Virtual Data Bus 238, which is responsible for synchronizing data between Third Party Services 240 on an ongoing basis.

In some embodiments, Third Party Services 240 represent separate software services with each one filling a business critical need for Business 200. For example, Connected System A 241 can include a CRM System which tracks data, processes, and key metrics related to sales operations, while Connected System B 242 can include a Marketing Automation System which fits a similar need for marketing operations, and Connected System C 243 can include a Finance System which manages routine invoicing and other mission-critical finance processes. As previously described, FIG. 1 illustrates a distributed business process incorporating three such systems.

In some embodiments, the Management Interface 236 can include a web-based administration system allowing User A 201 to instruct a Web Browser 216 and/or a Mobile Browser 218 to configure Service Level Agreement configuration 239 in order to automate data synchronization processes on behalf of said User. The Management Interface 236 can support multi-tenancy, meaning that the Interface may: (i) allow more than one User such as 201 to utilize a Client Device to access said Interface; (ii) include multiple Service Level Agreement configurations such as 239, which each being owned by one such User; and (iii) control access such that each Service Level Agreement configuration may only be accessed by a Client Device under the control of User which owns said SLA configuration.

Management Interface 236 can configure a Service Level Agreement configuration 239 specifying a policy for automated, continuous data synchronization. Once such a configuration is made, the Virtual Data Bus 238 can automatically synchronize data on a periodic ongoing basis, enforcing compliancy with SLA configuration 239 by executing remote data access operations on Third Party Services 240, including reading, creating, and updating data objects, in order to synchronize distributed data and processes on behalf of a User.

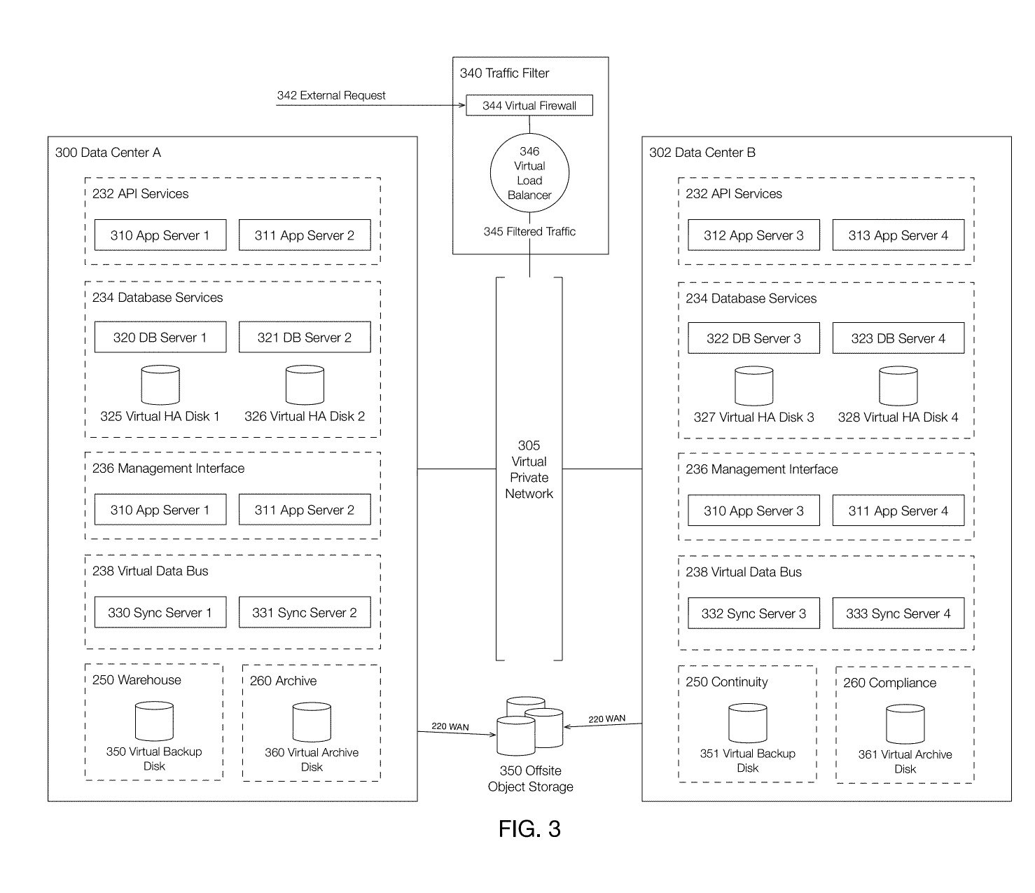

FIG. 3 illustrates the server architecture of Platform 230 in accordance with some embodiments. The virtual data integration platform 230 can be provided by a cloud service provider to supply virtual hosting components, such as Virtual Data Center A 300, Virtual DB Server 1 320, Virtual Backup Disk 350, and/or Virtual Private Network 305. This highly available, durable embodiment of Platform 230 allows clients to meet Business Continuity and/or Compliancy needs where applicable.

In some embodiments, any incoming interaction between a User such as 201 and the application is visualized as External request such as 342. The External Request 342 can include any type of instruction from a Client Device, including, for example, an instruction to administer the Service Level Agreement configuration, an instruction to write or retrieve data stored locally within the Platform 230, and/or an instruction to manage a billing account.

In some embodiments, the External Request 342 can be formatted as a stream of Hypertext Transfer Protocol (HTTP) requests. In other embodiments, the External Request 342 can be formatted using other protocols. For example, the External Request 342 can be formatted as a two-way message exchange to pass messages bi-directionally between a client and server; or, in a peer-to-peer application, the External Request 342 can be formatted as a broadcast message asynchronously targeting a multitude of peers.

In some embodiments, the Platform 230 can include several primary modules, each of which is deployed on top of virtual hosting components. All of the primary modules can be connected via Virtual Private Network 305, and therefore individual modules may communicate with each other freely via Virtual Private Network 305.

In some embodiments, the virtual data integration platform 230 can be implemented using one or more data centers. For example, FIG. 3 illustrates that a data center 300 includes the modules associated with the virtual data integration platform 230. A data center can include one or more servers.

When the Platform receives the Request 342, the Request 342 first traverses Virtual Firewall 344, which filters traffic so as to defend the system against certain classes of security breaches. Filtered Traffic 345 includes traffic which is explicitly allowed by Firewall 344, which next traverses Virtual Load Balancer 346.

In some embodiments, the Load Balancer module 346 can be configured to select an available, functioning server in Management Interface 236, such as App Server 1 310, App Server 2 312, App Server 3 312, or another such App Server, and forward the Request 342 to said server for fulfillment. The Load Balancer module 346 can actively monitor the status or health of the components in Management Interface module 346, such that if one or more components are experiencing internal issues (such as issues with internal disks, RAM, CPU, or other resources), or external issues (such as network issues), which are negatively impacting their ability to fulfill requests properly, Load Balancer module 346 routes traffic in such a way so as to avoid such problematic servers, instead sending the request to a server which is functioning correctly, if such a server is available. In other embodiments, such as one focused on lowering fixed resource costs, one might elect to implement the Load Balancer 346 differently, such that, for example, external requests are forwarded to the lowest cost server which is capable of fulfilling the request, depending on the request's complexity, accepting temporary failure in cases where the chosen server is having problems with request fulfillment.

Regardless of which server is selected, Management Interface module 236 may complete the response utilizing only internal components, or it may delegate the operation, in part or in whole, to one or more peer components such as Database Services module 234, API Services 232, and so on.

In some embodiments, Database Services module 234 can utilize components across Data Centers 300 and 302. This includes DB Servers 320-323, which run the chosen database software, as well as Virtual High Availability (HA) Disks 325-328, which maintain the data stored by each database service. The exact configuration of DB Servers, including their number and distribution across data centers, can be governed by business and technical constraints specific to the database software being utilized.

In some embodiments, API Services module 232 can utilize components which are similarly distributed across data centers. The Virtual Load Balancer module 346 can be accessed via internal traffic from peer components, as well as via Filtered Traffic 345, in order to dynamically select an App Server as described previously.

In some embodiments, Virtual Data Bus module 238 can also utilize distributed components, such that individual server failures, or even entire data center failures, do not cause overall failure of the application. Rather, any components which remain functional are able to continue operating normally.

In some embodiments, the Warehouse module 250 can utilize Virtual Backup Disks 350-351 in order to maintain a mirror image of all components. It may also maintain successive copies of said data, for example daily or monthly snapshots, or a combination thereof, or of one or more other time intervals. Such snapshots provide a layer of safety in various potentially catastrophic failure scenarios, most importantly those where a problem with the backup system itself causes snapshots to be successively corrupted as time passes and the snapshots are rotated on a recurring basis. The size of Virtual Backup Disk 350, and therefore the number of successive snapshots which can possibly be retained, will vary depending on business constraints.

In some embodiments, the Archive module 260 uses Virtual Archive Disks 360-361 to maintain long term archives in order to satisfy business constraints, government regulations, industry standards, and/or other data retention policies. Such retention polices often focus on auditable logs of administrative activity, so that breaches in data access compliancy constraints can be detected. For example, server logs may be retained for a certain period of time, often 7 or more years, in order to satisfy such constraints.

In some embodiments, the Offsite Object Storage module 350 maintains an offsite copy of all components included in Warehouse module 250 and Archive module 260, in order to ensure business continuity, even in the face of, for example, certain classes of events which could be potentially catastrophic, such as natural disasters.

Some embodiments of FIG. 3 may structure the system differently. For example, in a security-focused embodiment of the system, one would segment Network 305 such that high level application components including API Services 232, Database Services 243, Management Interface 236, etc, may have their respective inter- and intra-component communications governed by strong access controls in compliance with relevant corporate security policies, government security policies, industry security standards, or similar. Of course the security-focused implementation is in turn just one alternate embodiment of said System, and one can envision other such alternatives, with differing areas of focus, such as performance, monetary cost, and/or human resource cost, leading to a multitude of potential configurations, with each configuration fashioned differently in terms of virtual hosting components in order to meet the respective business constraints of said embodiment.

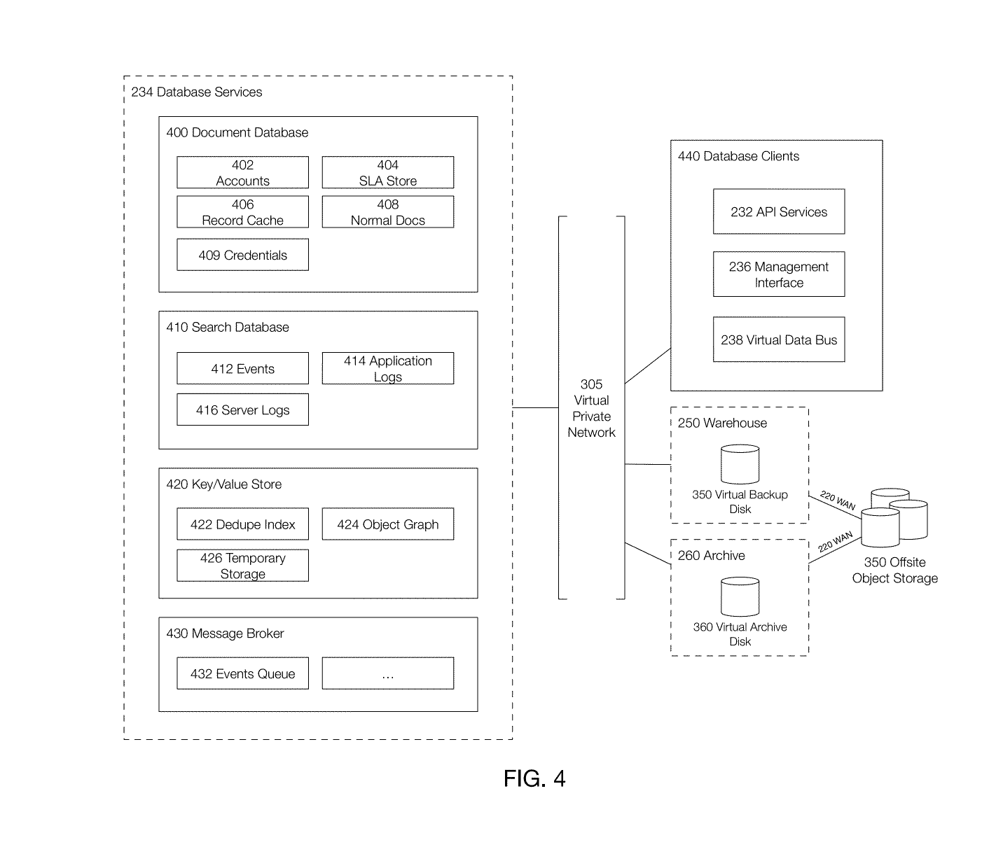

FIG. 4 illustrates Database Services components in accordance with some embodiments. Each database service component is responsible for storing data in some abstracted form, for example in the form of documents in a collection, in the form of keys in a dictionary, in the form of messages in a queue, and so on. Database Services components communicate with the peer services shown, such as Database Clients module 440, and/or Warehouse module 250, via Virtual Private Network 305.

In some embodiments, the Document Database module 400 is configured to store arbitrary, schema-less documents. For purposes of discussion, these documents can be treated as JSON documents in terms of their structure (arbitrary collections of property names and associated values of various types, with arbitrary nesting), although any particular embodiment of the Platform may decide to use a different storage format entirely, depending on the specific constraints of said implementation. Document Database module 400 supports structured queries (such as finding any documents where a specified attribute has a certain value), and configurable indexes allowing for optimization of such queries. In addition, many implementations support some form of data analysis, including map/reduce, aggregation queries in some predefined language such as SQL or a custom query language, and so forth.

In some embodiments, the Search Database module 410 is configured to store arbitrary objects, similar to Document Database module 400. However, in contrast to the Document Database module 400, Search Database module 410 is designed for dynamic, unstructured search queries. An example search query might be a string of characters such as “frank”, where the goal is to find any documents where any field includes that string (in this case, finding documents where any field includes the string “frank”). Such a query might find a document where First Name=“Frank”, in addition to a separate document with First Name=“Annie” and City=“Frankfurt”. Most implementations of such a database provide a rich unstructured query language, allowing the user to employ advanced search techniques such as wildcard searching, while maintaining acceptable levels of performance. Still, embodiments with extremely stringent performance constraints might implement this component differently, for example, one might use a highly specialized database implementation, perhaps even a custom one built specifically for this purpose.

In some embodiments, the Key/Value Store module 420 is configured to store arbitrary name/value pairs, generally allowing very fast access for both reads and writes since keys are always known ahead of time and the system can be designed for direct access by unique key, as opposed to the query-based approaches seen with the other types of databases described above. In a performance-based embodiment of the System, the Key/Value Store module 420 can store all keys and values in RAM, allowing for potential sub-millisecond access. Most implementations of the Key/Value Store module 420 can allow at least two operations: set the value associated with a given key, and get the value associated with a given key. However, for simplicity, this disclosure assumes a more sophisticated implementation where common data structures are understood (such as lists and sets) and common operations are available (such as adding an element to a set, removing an element from the end of a list, etc). This leads to the simplest possible explanation of the Sync Mechanism module. However, any such operations could be implemented directly in embodiments of the System where the implementation of Key/Value Store 420 does not support such structures and operations.

In some embodiments, Message Broker module 430 can be responsible for managing bi-directional communication channels between peer services, such as the various components of Virtual Data Bus 238 in a messaging-based implementation of that component. Many implementations provide durability guarantees, such that the state of such communications channels is reliability retained in case of internal or external failure scenarios.

In some embodiments, each of the database services mentioned here, 400, 410, 420, and 430, may have implementation-specific constraints for proper backup protocols. For example, a special database command may need to be executed previous to taking a virtual disk snapshot, in order to ensure the consistency of the database at that time. Therefore, each database service may have its own custom backup protocols. Regardless of the backup protocols, whether custom or generic, each backup service will utilize a regularly tested backup procedure in order to take such snapshots and transfer them to Warehouse module 250 and/or Archive module 260 as appropriate to meet business constraints.

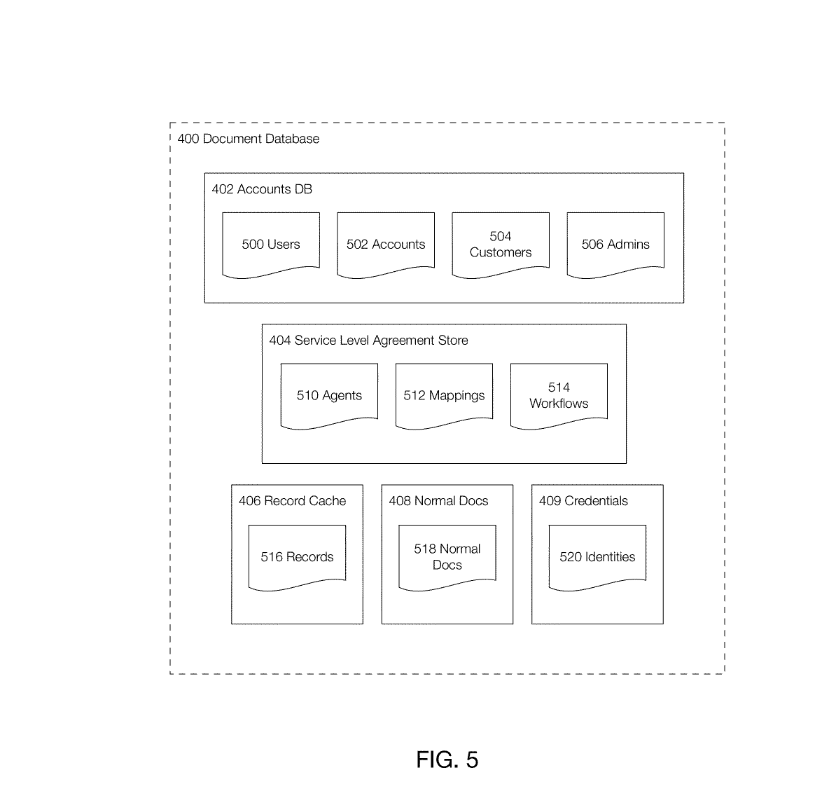

FIG. 5 illustrates a listing of data components which can be stored by Document Database module 400 in accordance with some embodiments. Data is broken into a series of databases, such as Accounts module 402, Service Level Agreement Store module 404, Record Cache module 406, Normal Docs module 408, and Credentials module 409. The structure of these database modules may have performance implications depending on which database implementation is chosen. In the embodiment of the System described in this disclosure, the databases are arranged logically for purposes of discussion, but other structures may be more optimal depending on business constraints.

In some embodiments, Accounts module 402 can store data related to user authentication and authorization; Users 500 is a collection of documents where each document represents a user of the system such as User 201, specifically including all details which allow the System to authenticate said user as part of a access protocol; Accounts module 502 maintains user profile information, and other user details which are not concerned with identity or authentication, such as the user's first and last name; and Customers module 504 includes information about individual billing accounts, which correspond to real-world business entities. In some embodiments each customer document references one or more documents in Accounts module 502, such that the System may support multi-tenancy by controlling access to data objects owned by individual customers.

In some embodiments, Service Level Agreement Store module 404 can include the details of each Service Level Agreement configuration 239, which consists of information pertaining to: authenticated Third Party Systems, stored in Agents module 510; configuration of the data mapping module, a component of Virtual Data Bus 238, stored in Mappings module 512; and configuration of the user-configurable workflow component of 238, stored in Workflows 514.

In some embodiments, Record Cache module 406 can store a local cache which reflects all data objects received from external system (e.g., third party systems), enabling change detection as future changes are received and/or calculated. In the embodiment of the System illustrated here, Records module 516 includes of a separate Document for each data object in every authenticated third party service specified by the Service Level Agreement configuration 239. Each Document in 516 can include a Record Reference, which uniquely identifies the data object, its source (a Connector Reference which uniquely identifies the Connector which produced the data object), and an arbitrarily nested data object comprised of Record Attributes. Of course, other embodiments might choose a different representation of third party data entirely, and some implementations might omit storage of the full data object data altogether, opting to store an artifact, such as a checksum, instead. One option is to implement Records module 516 as a versioned data store, meaning that the collection implicitly stores version metadata with each modification. This metadata can be used to achieve highly valuable goals including regulatory compliance, real-time business process analysis, pattern detection, and other types of data mining.

In some embodiments, Normal Docs module 408 can store deduplicated, normalized documents, each of which refers to a set of Record References referring to Records module 516, i.e. a set of deduplicated data objects from third party systems, all of which represent the same real-world entity. This association has some important attributes: it is singular, meaning that a given Record Reference may be associated with, at most, a single Normal Doc module 519 at any given point time; it is non-exclusive, meaning that more than one Record Reference can be associated with a given Normal Doc; and it is mutable, meaning that a given Record Reference can be dissociated from one Normal Doc and subsequently re-associated with a different one, so long as the result of such an operation meets these constraints. Each document in Normal Docs module 518 can also include a dictionary of key/value pairs where the key represents a mapped field name specified in a Mapping from 512, and the value represents the value for that field after conflict-resolution has been applied.

In some embodiments, Credentials module 409 can store identity information which is used to authenticate with Third Party Services 240 on behalf of User such as 201. Each document in Identities module 520 includes identifying metadata, as well as a set of encrypted “secrets” which, when decrypted, provide access to a particular Third Party System, such as Connected System A 241. In a security-focused embodiment of the System, these secrets may be public-key encrypted such that consumers of Credentials module 409 may write secrets without having the ability to read them, and keys with the ability to decrypt the secrets can be stored and accessed separately.

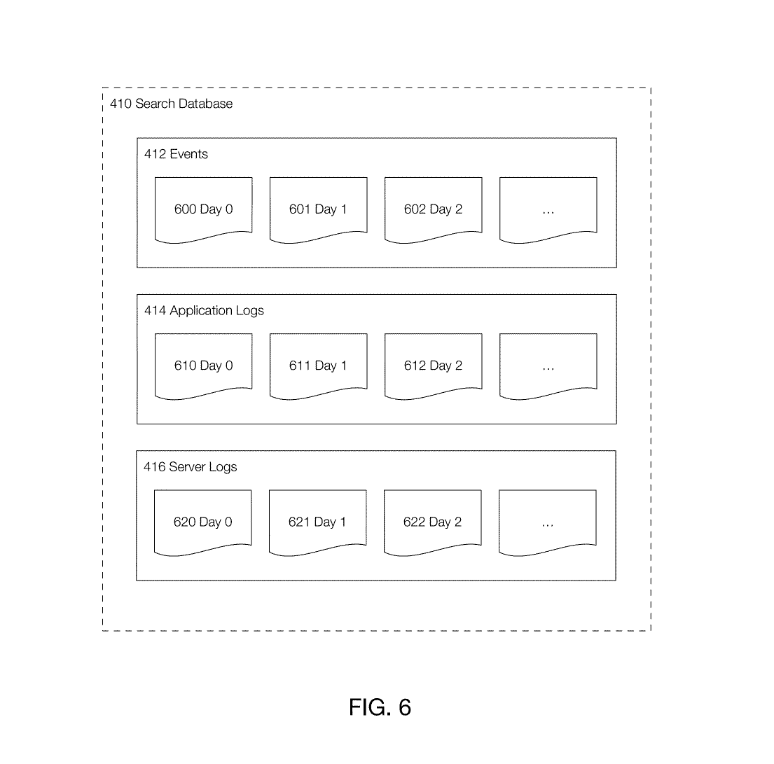

FIG. 6 provides a visual representation of data stored by Search Database 410 in accordance with some embodiments. The data may be organized into separate database modules: Events module 412, Application Logs module 414, and Server Logs module 416. In the embodiment of the System shown here, the time-series data stored in these collections is split into daily segments, which is a convenient organization for such data, as a Data Retention Policy can be explicitly defined which dictates the respective ages at which different time-series data points are dropped from primary storage in order to conserve disk space, after which time backup copies will continue to be retained by Warehouse module 250 and/or Archive module 260 in accordance with continuity and/or compliancy constraints. However, depending on the specific database implementation, which can vary with different embodiments, it may be desirable to structure this data differently. In the embodiment of the System pictured here, the underlying database structure is kept hidden from Database Clients module 440, such that said structural decisions, which relate to implementation-specific business constraints, do not affect other aspects of the overall system design.

In some embodiments, Events module 412 includes structured, time-stamped event objects which are emitted in a stream from Virtual Data Bus 238 as part of a general purpose publish/subscribe notification mechanism. Each day's worth of events may be stored in a separate collection, such as Day 0 600, facilitating simple retention and archival as described above.

In some embodiments, Application Logs module 414 can store log messages, which are typically unstructured strings of Unicode characters which may or may not conform to a common pattern, emitted in a stream from Management Interface 236, Virtual Data Bus 238, and other application-level components. These logs can include, for example: a history of operations performed by Management Interface 236 on behalf of a Client Device module 210 in control of a User 201 when configuring Service Level Agreement configurations such as 239; a history of automated operations performed by Virtual Data Bus 238 in order to maintain compliance with said Agreements; a history of backup and archival operations; a history of automated failure-response mechanisms; and so forth. Application Logs module 414 may be segmented by day as above.

In some embodiments, Server Logs module 416 can store similarly unstructured log messages, pertaining to server-level activities, including: remote access authorization for administration purposes; operating system and software package updates; application deployments by the System implementer; and so forth. Such data is often the focus of important business constraints, such as regulatory compliance, corporate security policies, industry standards, etc. As with the other time series data stored in Search Database module 410, this data can be stored in daily segments and subject to data retention and long term storage policies as above.

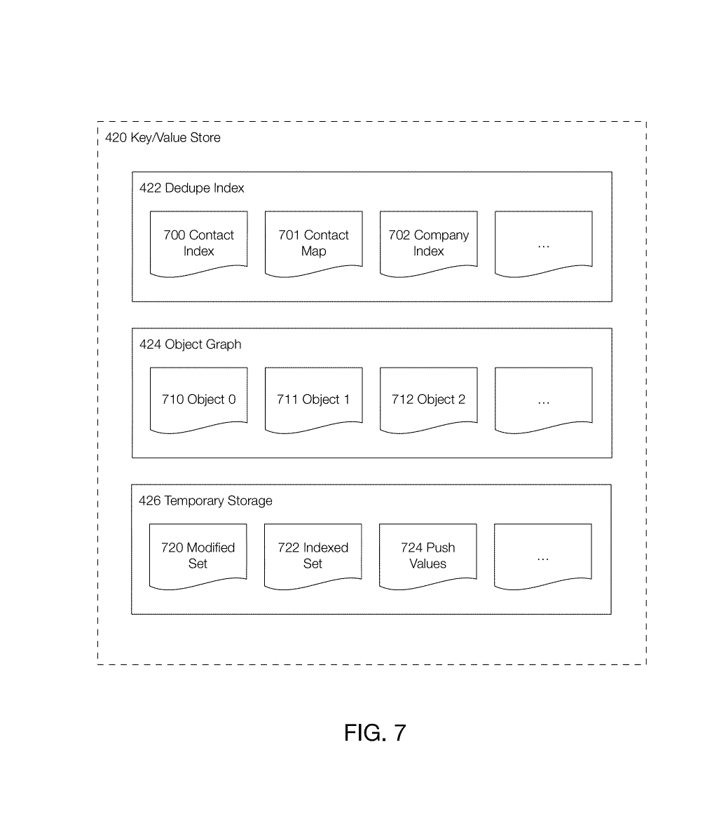

FIG. 7 shows data components provided within Key/Value Store module 420 in accordance with some embodiments. This Store module can combine very fast key lookups, flexible data structures, and powerful operators. There are three conceptual databases pictured, 422-426, each designed for a different purpose.

In some embodiments, Dedupe Index module 422 includes customized data structures used by the Virtual Data Bus 238 in order to determine when two or more data objects stored in separate third party systems represent a single real-world entity. Such data objects are said to be part of the same “deduplication set” or “dedupe set” for short, and are subject to synchronization by Virtual Data Bus 238 in compliance with current Service Level Agreement configurations. For example, if two contact data objects share the same email address, and are included in a configured SLA configuration, they are subject to synchronization. Contact Index module 700 includes a mapping from a data object identifier to the email address of said contact. Contact Map module 701 includes a mapping from a contact's email address to the set of one or more data object identifiers indicating data objects in third party systems which represent a contact with said email address. This two-way index is used by Virtual Data Bus 238 to make automated synchronization decisions on a continuous basis. While contact data is deduplicated via simple means (a shared email address), other data types may require more complex data structures in order to allow for efficient indexing and deduplication mechanisms. The System presented herein is designed for extensibility in this area, such that the system allows for a multitude of data types, including configurable data types which can be configured by Management Interface 236.

In some embodiments, Object Graph module 424 can maintain a conceptual “network” of objects, where each object may refer to one or more other objects, in order to model the relationships between objects that are central to the organization of data in third party services. Object Graph module 424 is designed for efficient traversal of the graph in response to real-time synchronization needs in order to maintain compliance with Service Level Agreement configurations.

In some embodiments, Temporary Storage module 426 can be a general purpose data store for temporary data with rapid access requirements. For example, Modified Set module 720 can collect modified data objects as they are identified by Virtual Data Bus 238. Later, after each data object can indexed by 238 and moved to the Indexed Set module 722. Later, 238 may determine that changes must be written to third party systems in order to comply with SLA configurations; when this occurs, the pending data values may be written to Push Values 724. This is a sampling of the types of uses for general purpose temporary storage typically found in a given embodiment of the System presented herein, of course, different embodiments may have different use cases for this data store.

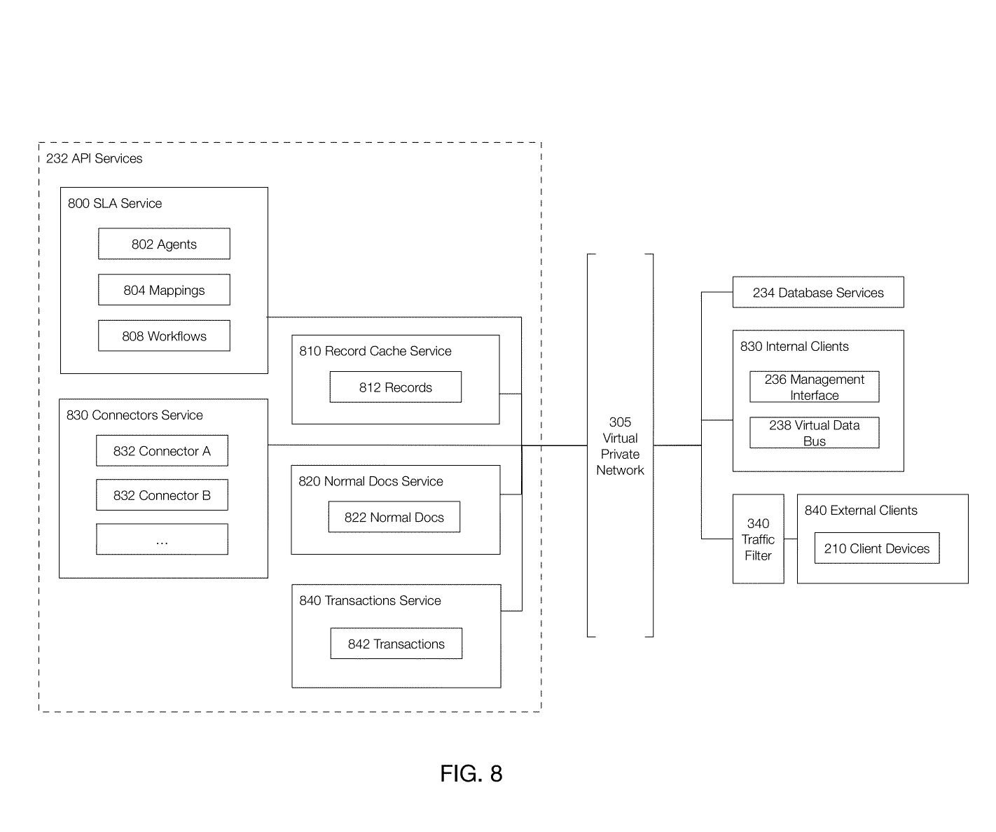

FIG. 8 illustrates the API Services components and their peers from a high level as they exist in accordance with some embodiments. API Services 232 can provide a centralized database access tier which is well positioned to enforce data validation logic and other data access routines. It can communicate with peer services such as Database Services module 234 via Virtual Private Network 305, and subsequently with the outside world via Traffic Filter module 340. The API Services are comprised of several individual application services, with a structure closely mirroring the database structures shown in FIGS. 4 through 7.

In some embodiments, SLA Service module 800 can facilitate management of Service Level Policies such as 239, with the structure Service 800 mirroring that of Service Level Agreement Store module 404, to which 800 proxies access.

In some embodiments, Record Cache Service module 810 can provide user and peer service access to data stored in the Record Cache database, 406.

In some embodiments, Normal Docs Service module 820 can provide user and peer service access to data stored in the Normal Docs database, 408.

In some embodiments, Connectors Service module 830 can proxy access to third party services, delegating each request to a particular Connector such as 832 which can perform a remote procedure call of some form in order to fulfill the request and return a relevant response, or helpful information in case of an error.

In some embodiments, Transactions Service module 840 can proxy access to the time-series data stored in Events module 412 using standard “RESTful” access patterns.

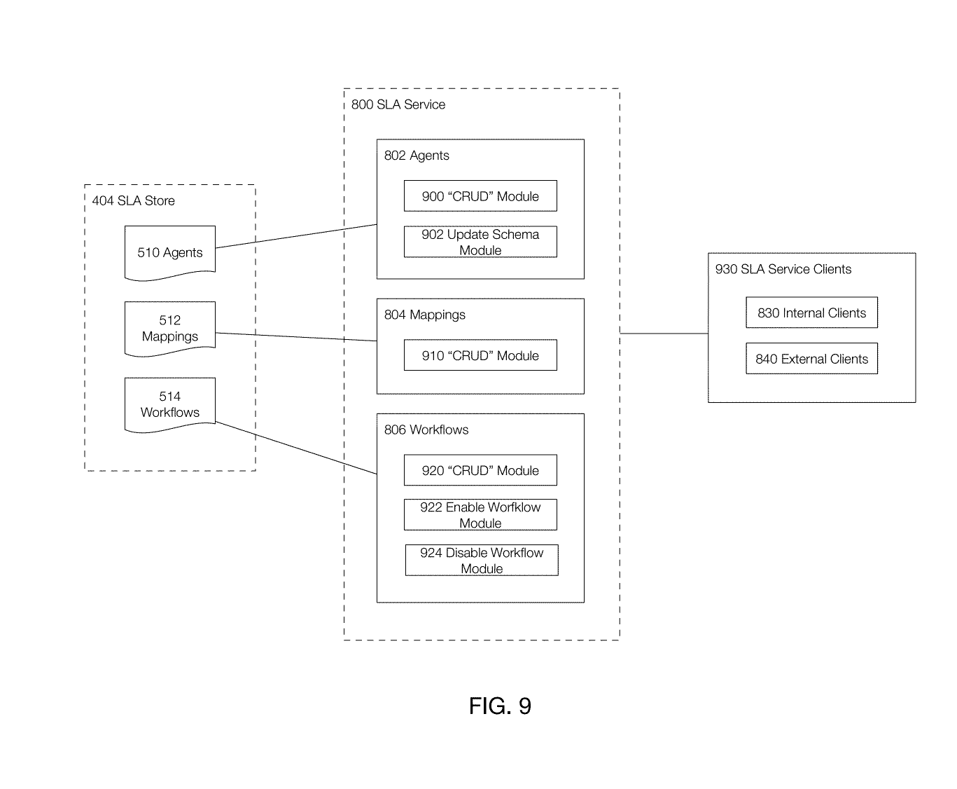

FIG. 9 illustrates a SLA Service module 800 in accordance with some embodiments. The Configuration Service module 800 can facilitate the configuration of Service Level Agreement configurations such as 239. Service module 800 features three primary components, each of which can be conceived as a sub-service including a set of modules which may manage some subset of the data stored in Service Level Agreement Store module 404.

In some embodiments, Agents module 802 can provide access to the Agents module 510 portion of Service Level Agreement Store module 404, with such access including the two sub-modules shown in the diagram. “CRUD” Module 900 refers to the basic operations of “create”, “read”, “update”, and “delete”, which means that 900 can provide the ability manage documents in Agents module 510. Each document in 510 specifies: a third party service; credentials for said third party service; settings which allow the user to control the System's interaction with said third party service; and other details. That is, “CRUD” Module 900 can allow management of the list of third party systems to be kept in sync by Platform 230. In some embodiments Update Schema Module 902 can allow for the System to be notified after configuration changes occur in a third party system, such that Platform 230 may read this updated configuration, such that it may be utilized by Management Interface 236 and Virtual Data Bus 238.

In some embodiments, Mappings module 804 can provide an access point for the documents stored in Mappings 512, which can configure the behavior of the Data Mapping component of Virtual Data Bus 238. As with 900 above, “CRUD” Module 910 refers to the basic resource-oriented operations which may be performed against the accessible subset of documents stored in Mappings 512, such as “create”, “read”, “update”, and “delete”. That is, Module 910 can allow for configuration the portion of Service Level Agreement configuration 239 related to field mappings and conflict resolution, which is applied by Virtual Data Bus 238 while synchronizing data automatically.

In some embodiments, sub-service Workflows module 806 can proxy access to the documents stored in Workflows module 514. As with 900 and 910 above, “CRUD” Module 920 refers to resource-oriented operations against the database collection in question, in this case Workflows module 514. This can allow for configuration of the portion of SLA configuration 239 which controls: which data objects should/should not be managed by Virtual Data Bus 238; the use of trigger-based actions to perform automatically in response to changes in third party systems; automated data management actions; and so forth. Workflows module 514 calls such instructions “rules” and a collection of such “rules” is called a “workflow.” A given Service Level Agreement configuration can have zero or more workflows. Enable Workflow Module 922 can allow for activation of a particular workflow, such that it is included in SLA configuration 239 and therefore Virtual Data Bus 238 will process said workflow in order to ensure compliance with said SLA configuration. Disable Workflow Module 924 does the inverse, allowing for deactivation of a workflow, such that it is not included in SLA configuration 239 and therefore Virtual Data Bus 238 will not process said workflow.

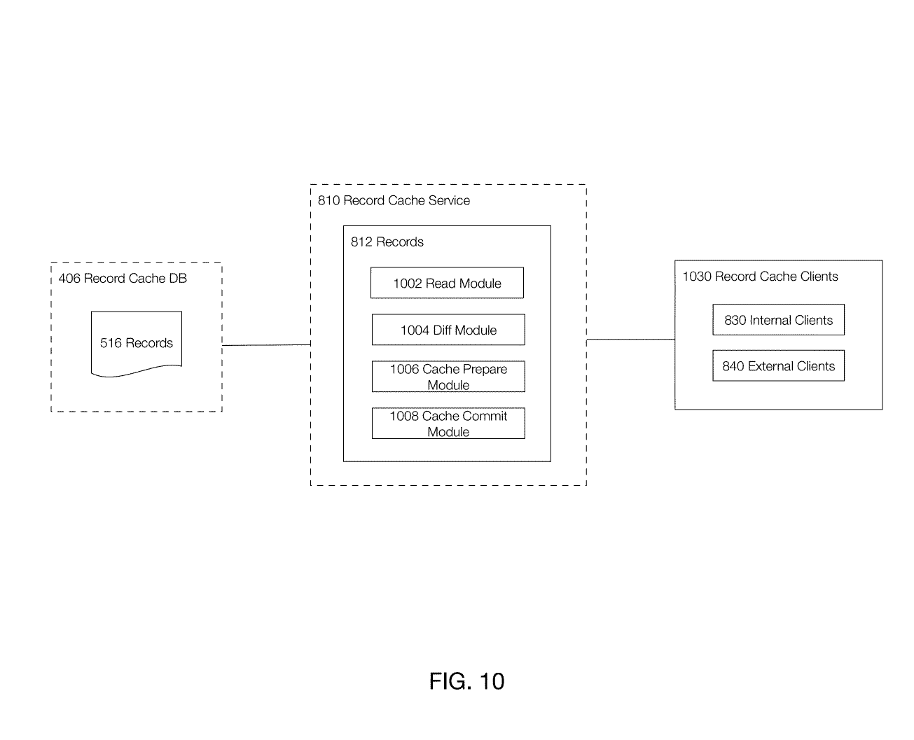

FIG. 10 shows a Record Cache Service module 810 in accordance with some embodiments. The Record Cache Service module 810 can maintain cached third party data objects in accordance with some embodiments, supplying change detection and a handful of other key functions needed by the Virtual Data Bus 238.

In some embodiments, sub-service Records 812 accesses Records 516, the solitary collection of Record Cache DB 406, via a set of modules: Read Module 1002, Diff Module 1004, Two-step Update Module 1006, and Soft Delete Module 1008.

In some embodiments, Read Module 1002 can accept as input a Record Reference. Read Module 1002 can search for a Document such as 517 with said Reference, and, if said Document is found, produces output including its enclosed Record Attributes.

In some embodiments, Diff Module 1004 can accept as input a Record Reference and an object of Record Attributes. Diff Module 1004 can search for a Document such as 517 with said Reference. If such a Document is not found, Process 1004 can produce output indicating that the data object does not exist. If, however, such a Document is found, Module 1004 can calculate a Difference Report describing any and all difference(s) between the given Record Attributes and the actual Record Attributes stored in said Document. It can then produce output including representative of said Difference Report. If instead the search process fails to locate a Document with the given Record Reference, it can produce output indicating that no such data object exists.

In some embodiments, Cache Prepare Module 1006 can accept as input a Record Reference and an object of Record Attributes. When invoked, Cache Prepare Module 1006 can search for a Document such as 517 with said Reference. If such a Document is found, Module 1006 can calculate a Difference Report as in Diff Module 1004, adding the given Record Attributes to the Document's internal modification buffer, which is an attribute of Document 517 including one or more sets of Record Attributes which have been collected in this manner by Module 1006. If no such Document is found, Module 1006 can create a Document with said Reference, adding the given Record Attributes to the Document's (empty) internal buffer. Finally, Module 1006 can produce output indicating the actual operation performed (“create” or “update”), and, in the case of “update”, the Difference Report indicating the differences between the given Record Attributes and those found in the previously stored Document.

In some embodiments, Cache Commit Module 1008 can accept as input a Record Reference. When invoked, Module 1008 can search for a Document with said Reference and, if found, can update the Document's Record Attributes such that they reflect any Record Attributes stored in the Internal Buffer described above, merging subsequent sets of attributes such that, when more than one value for a given attribute exist in the Buffer, the most recent value received for a given attribute can be written to the Document.

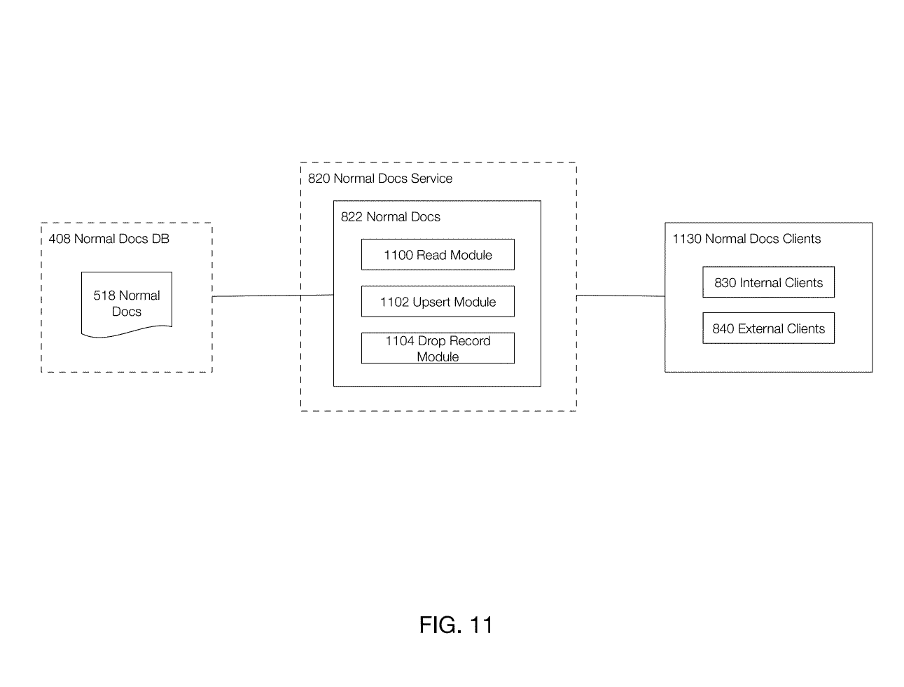

FIG. 11 illustrates a Normal Docs Service module 820 in accordance with some embodiments. The Normal Docs Service module 820 can provide access to Normal Docs 518, the sole collection of Normal Docs DB 408. Service 820 can include a single sub-service, Normal Docs 822, which is comprised of several modules: Read Module 1100, Upsert Module 1102, and Drop Record Module 1104. One common feature of these modules is an Input Negotiation mechanism, whereby a given Document Reference can be identified as either: a unique Document Id, typically issued by the underlying database software; or, the Record Reference of some Cache Record 517. The outcome of said identification can determine the appropriate Document Location mechanism, which can be either: to fetch a Document 519 directly by unique Document Id; or, to search for a Document 519 by Record Reference (noting that a set of such Record References is an attribute of such Documents in Normal Docs 518).

In some embodiments, Read Module 1100 can take as input a Document Reference. When invoked, Module 1100 can first invoke the previously described Input Negotiation mechanism, followed by the resulting Document Location mechanism. If a Document 519 is found, Module 1100 can produce output including the Document's attributes. Otherwise, 1100 can produce output indicating that such a Document does not exist.

In some embodiments, Upsert Module 1102 can take as input a Document Reference, a dictionary of zero or more Data Attributes, and a list of zero or more Record References. When invoked, Module 1102 can invoke the Input Negotiation and Document Location mechanisms as above. If a Document 519 is found, Module 1102 can update said Document, updating the Document's Data Attributes with those given as input, and adding any given Record References to the preexisting References included in the stored Document. If such a Document 519 is not found, Module 1100 can create a new Document 519 with the given Data Attributes and Record References. In either case, 1100 can produce output including the resulting Document's Data Attributes and Record References.

In some embodiments, Drop Record Module 1104 can accept a Record Reference as input. When invoked, Module 1104 can search for a Normal Doc 519 with the given Record Reference and, if found, remove the given Record Reference from said Normal Doc, such that it may be associated with a different Normal Doc in the future.

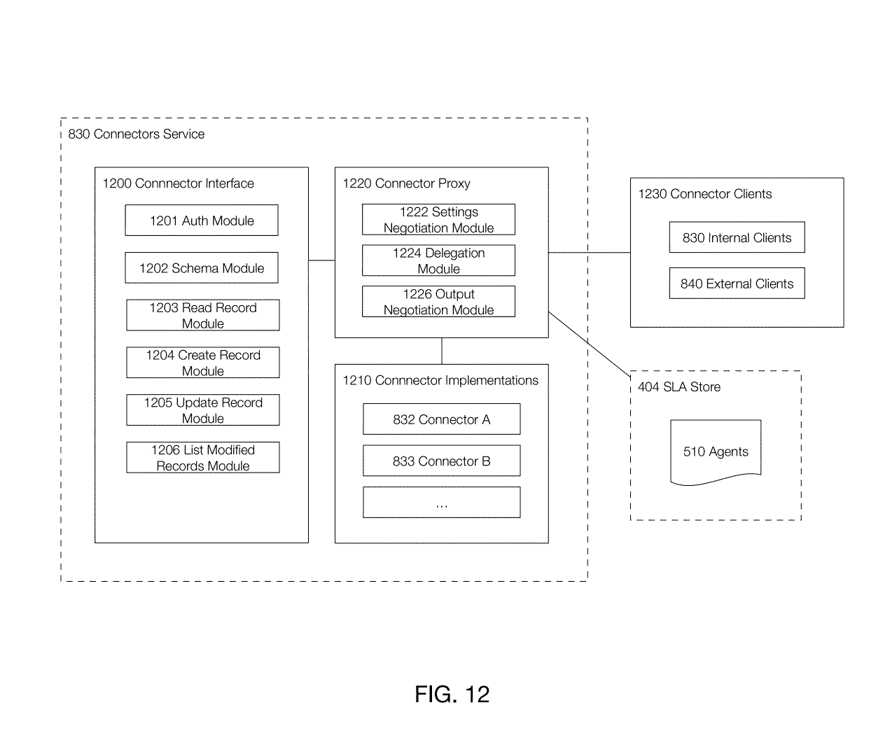

FIG. 12 illustrates a Connectors Service module 830 in accordance with some embodiments. The Connectors Service module 830 can proxy access to Third Party Services 240 via a Connector Implementation from 1210, such as Connector A 832, where a Connector Implementation is a module including sub-modules adhering to Connector Interface 1200, meaning that all Connector Implementations support corollaries of the sub-modules defined by this Interface, such as Auth Module 1201, Schema Module 1202, and so forth. Each Connector Implementation can handle the details of these modules differently, delegating responsibility to a Third Party Service from 240, with the details of said delegation depending entirely on the constraints of the Third Party System in question. Connector Proxy 1220 can handle Client Requests, delegating each one to a chosen Connector Implementation.

In some embodiments, the Connector Proxy module 1220 can be a sub-service of Connectors Service 820, which can handle a stream of Client Requests from Connector Clients 1230, implemented in this embodiment of the System using the HTTP Protocol (i.e. each Client Request can be an HTTP Request, and an HTTP Server can forward incoming requests to Connector Proxy 1220. Other embodiments of the System might choose a different protocol (or even a multitude of protocols) depending on the specific implementation constraints involved. Connector Proxy 1220 can include three sub-modules, which are integrated into a single data pipeline which is invoked for each Client Request. That is, for each Client Request forwarded from the HTTP Server, the Connector Proxy can invoke the following modules: first, Settings Negotiation Module 1222; then Delegation Module 1224, using the output of 1222 as the input to 1224; and finally, Output Negotiation Module 1226, using the output of 1224 as the input to 1226.

In some embodiments, Settings Negotiation Module 1222 can analyze the Client Request and produce a dictionary of connector settings, which can be configuration metadata used by the Connector Implementation—such as credentials which are used to access the Third Party Service, configuration parameters which affect the Connector Implementation's behavior, and so forth. For each received Client Request, Module 1222 can decide whether to utilize Settings which have been included with the Request itself, or whether to load the Settings from Agents 510. Either way, Module 1222 can produce output including the selected Settings.

In some embodiments, Delegation Module 1224 can receive the selected Settings as input, and can further analyze the incoming Client Request in order to determine: (a) which concrete Connect Implementation from 1210 should be used (this information is specified explicitly by the Client Request, carried in this HTTP-based implementation in either the HTTP Request's URL Path, Query Parameters, or Request Body); and (b) which Interface Sub-Module from Connector Interface 1200 to invoke on said Connector Implementation. Module 1224 can then obtain an Instance of the selected Connector Implementation parameterized with the given Settings, either by constructing said instance directly, invoking a factory method, or via some other implementation-specific means. Module 1224 can then invoke Interface Sub-Module from (b) above, passing the given Settings and Client Request as input. The selected Connector Interface Sub-Module completes, producing output which is then propagated as the result of Delegation Module 1224.

In some embodiments, Output Negotiation Module 1226 can receive the result of the Interface Sub-Module as input, and can transform the data included therein to an HTTP Response, which is subsequently sent to the client. Connector Proxy 1220 continually waits for incoming Client Requests, each of which causes a separate execution of this data pipeline.

In some embodiments, Connector Interface 1200 can include a set of sub-modules which are implemented by each Connector Implementation from 1210, with each different Implementation including different details, depending on the constraints of the Third Party Service associated with said Implementation.

In some embodiments, Auth Module 1201 can allow clients of the service 830 to validate a given set of credentials. This would allow, for example, the Management Interface 236 to validate user input when a Client Device attempts to configure a new Agent on behalf of a User. Module 1201 can return a successful response when proper Settings are provided, such that other modules in Connector Interface 1200 will be able to connect to the appropriate Third Party Service from 240 successfully. Otherwise, Module 1201 can return an error response, including information which identifies the problem (for example: “invalid API key”, or “username is required”, depending entirely on the constraints and capabilities of the Third Party API).

In some embodiments, Schema Module 1202 can be the connector to the Third Party System associated with the Connector Implementation in question and produce a Schema Document which can include metadata information specifying, for example, what Record Types as well as what Data Fields are exposed by this particular Connector Implementation, given the Settings associated with the Client Request. Note that the Schema Document may vary depending on the provided settings because, for example, one set of credentials may have access to an instance of the third party service where certain custom fields have been defined, whereas another set of credentials may access an instance of the third party service with no such fields. The Schema Document can also include a significant amount of other metadata which can be used by Virtual Data Bus 238 to make automated decisions during the continuous synchronization process.

In some embodiments, Read Record Module 1203 receives a Record Type (such as “contact” or “company”—one of the Record Types included in the Schema Document) and a unique Record ID which unique identifies a Record in the Third Party System. Module 1203 can connect to the Third Party System, executing a Remote Procedure in order to search for a data object with the given Record Type and Record ID. If such a Record is found, Module 1203 can produce output including said Record's data attributes. If such a Record is not found, Module 1203 can produce output indicating that such a Record does not exist.

In some embodiments, Create Record Module 1204 can receive a Record Type and a dictionary of Data Attributes, representing field-level data for the Record (following the structure of Fields defined for this Record Type in the Schema Document). Module 1204 can connect to the Third Party System and executes a Remote Procedure to create a data object with the given Record Type and Data Attributes. On success, 1204 can produce output indicating the newly created data object's unique Record ID. On failure, 1204 can produce output indicating that data object creation failed, including any error message(s) returned from the Remote Procedure Call.

In some embodiments, Update Record Module 1205 can receive a Record Type, a unique Record ID, and a dictionary of Data Attributes. In response, module K-4 can connect to the Third Party System, executing a Remote Procedure to update a data object with the given Record Type and Record ID, transmitting the given Data Attributes such that they may be written to the indicated data object. 1204 can produce output indicating whether the operation succeeded or failed which, in the case of failure, can include any error message(s) returned from the Remote Procedure Call.

In some embodiments, List Modified Records Module 1206 can receive a Record Type and a Paging Cursor, where a Paging Cursor can be an opaque value which can be used to iterate over data objects as they change through time. For example, a Paging Cursor can specify that only Records modified since a certain point in time (also specified by said cursor) should be returned. Process 1206 can read the Paging Cursor, connect to the associated Third Party System, and make a Remote Procedure Call to fetch Records of the given Record Type matching the conditions given in the Paging Cursor. Module 1206 can produce output including any matching data objects, followed by a new Paging Cursor which may be used to fetch the subsequent page of Records. By invoking Module 1206 repeatedly, propagating the retuned Paging Cursor from one Client Request to the input Paging Cursor of a subsequent one, clients may scan the entire data set included within the associated Third Party System. The final Paging Cursor from a such a sequence can be stored and used again at some later date in order to fetch any Records which have been modified in the interim period; for example, storing a Paging Cursor for five minutes, then using the stored Paging Cursor to invoke Module 1206, could return Records modified during the preceding five minutes. This feature can be utilized by Virtual Data Bus 238 in some embodiments in order to search for modified data objects in only a finite time window during automated synchronization.

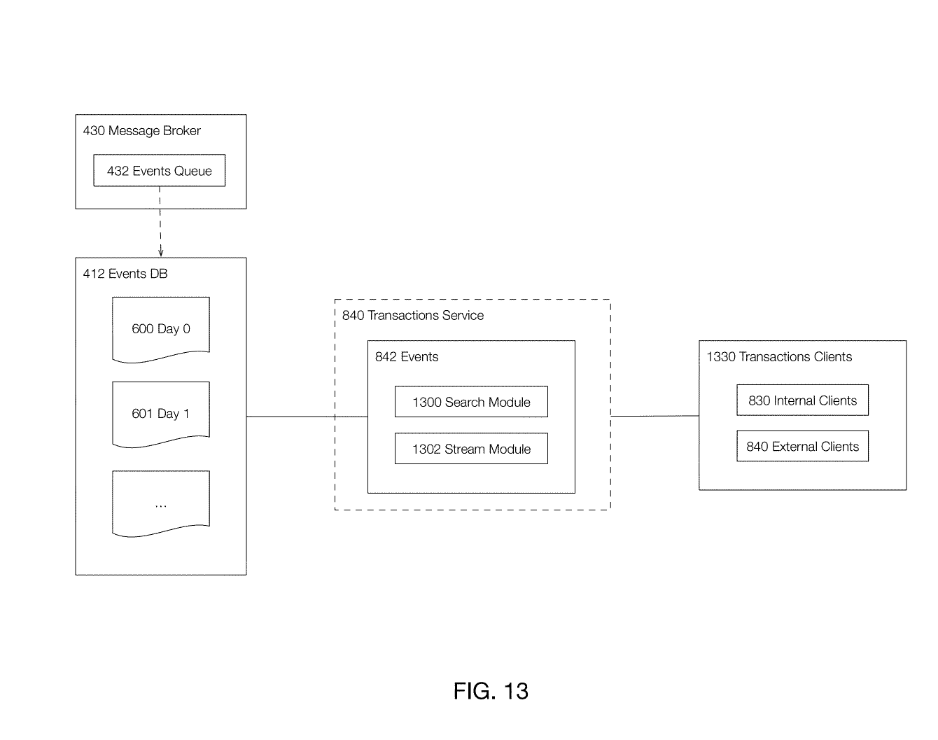

FIG. 13 illustrates a Transactions Service module 840 and its sole sub-service Events 842 in accordance with some embodiments. The Transactions Service 840 and its sole sub-service Events 842 can access Events DB 412 in order give Transactions Clients 1330 a view of recent automated sync operations undertaken by Virtual Data Bus 240. Events 842 can include Search Module 1300 and Stream Module 1302.

In some embodiments, Search Module 1300 can receive a set of Search Parameters, including a keyword query, an optional event type, a date range, and other filtering criteria. Module 1300 can search for Events from Events DB 412 which match the given Search Parameters, possibly querying multiple collections such as Day 0 600 and Day 1 601, depending on the requested date range. Module 1300 can produce output including any found Events matching the given Search Parameters.

In some embodiments, Stream Module 1302 can receive a set of Search Parameters, mirroring those accepted by Search Module 1300. Module 1302 can connect to Events Queue 432, filtering events in real time as they are received, and propagates matching events to the calling Client. This can enable a real-time monitoring interface, the automated operations of Virtual Data Bus 240 can be displayed in real time as they are performed.

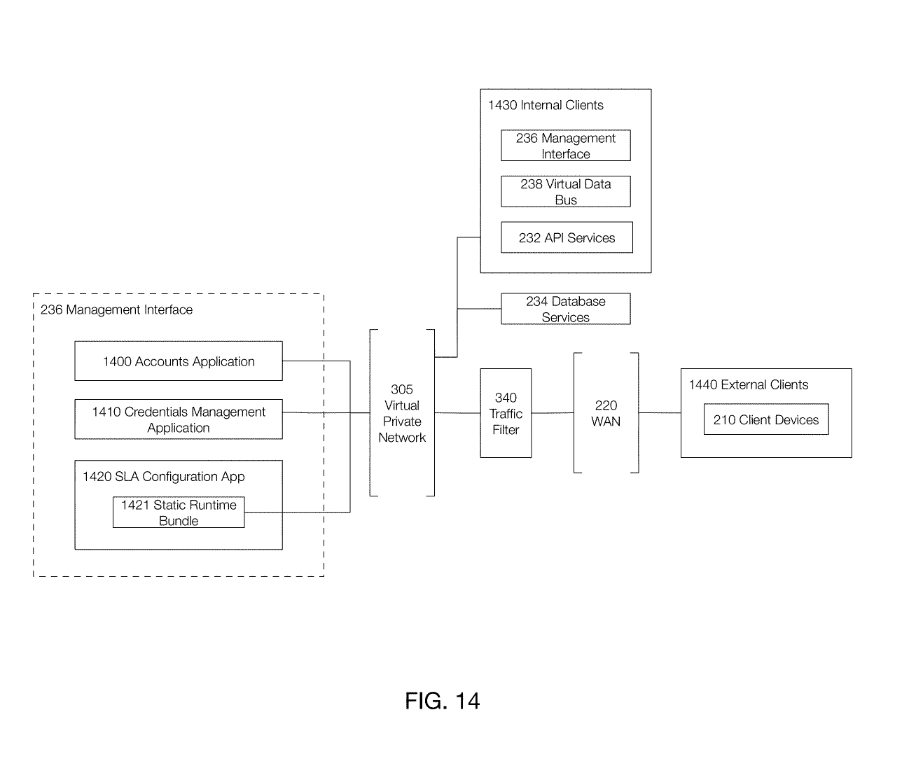

FIG. 14 illustrates Management Interface 236 in accordance with some embodiments. The Management Interface 236 can provide a User Interface which can configure a Service Level Agreement configuration such as 239, which in turn can configure the automated synchronization managed by Virtual Data Bus 238. Management Interface 236 can include three applications: Accounts Application 1400, Credentials Management Application 1410, and Web Application 1420.

In some embodiments, Accounts Application 1400 can provide authentication, authorization, and associated faculties, via a traditional web application. 1400 can instantiate a shared session which can be consumed by other platform components, including other applications with Management Interface 236 as well as API Services 232. In other embodiments of Platform 230, this session-sharing mechanism might be implemented differently, for example, rather than sharing a session directly with other components, a security-focused implementation would likely opt to have a login session which only identifies Client Devices to Accounts Application 1400 using a system of access tokens (possibly implementing a standard authorization flow, such as an OAuth 2.0 Client flow).

In some embodiments, Credentials Management Application 1410 can be a traditional web application which can be responsible for: authenticating a User with a specified Third Party System from 240; saving authenticated credentials securely; and, providing access to said credentials such that only authorized clients may read them.

In some embodiments, Configuration Application 1420 can be implemented as a Static Runtime Bundle which is downloaded to a Web Browser 216 or a Mobile Browser 218 which runs the included instructions, which can make a series of requests to API Services 232, displaying a User Interface which can configure a Service Level Agreement configuration such as 239 which can govern the automated synchronization activities of Virtual Data Bus 240. In other embodiments of the System, this component may be implemented differently. In a mobile-focused implementation, for example, one might prefer to implement this component as a native mobile application on one or more mobile operating systems.

In some embodiments, these applications comprising Management Interface 236 can communicate with each other, as well as Internal Clients 1430 and Database Services 234 via Virtual Private Network 305. These applications can also receive requests from external sources; to accomplish this, External Clients 1440 can connect to Traffic Filter 340 across WAN 220, and any allowed traffic can proceed to its destination application across Private Network 305.

In some embodiments, the applications comprising Management Interface 236 can be designed in accordance with a common software design pattern called the Model View Controller (MVC) pattern. Systems adhering to MVC are typically organized into three top-level components: one or more Models, which provide database access, data validation logic, and other forms of business logic; one or more Views, which display Model data; and one or more Controllers, which respond to incoming requests by utilizing one or more Models to fetch or modify data relevant to the request, and, generally speaking, subsequently utilize one or more Views to display said data.

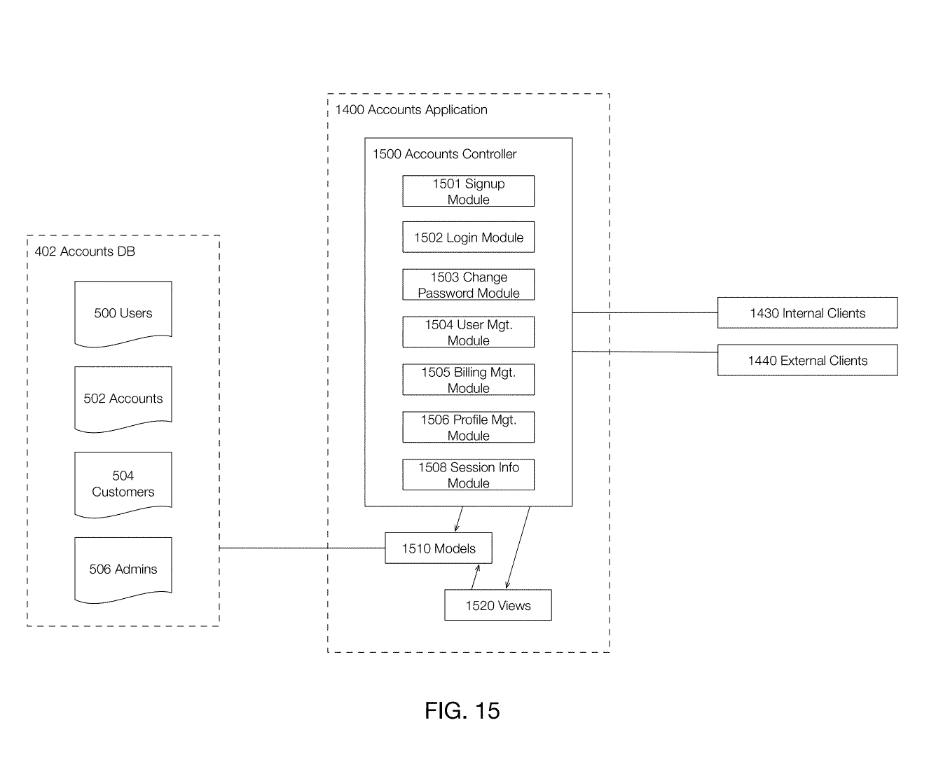

FIG. 15 illustrates the modules and components utilized in Accounts Application 1400 in accordance with some embodiments. Application 1400 can be organized using the MVC pattern described above. It can define a series of Models 1510, with one Model being defined for each displayed collection from Accounts DB 402, namely: Users 500; Accounts 502; Customers 504; and Sessions 506. It can also define a series of Views 1520, with roughly one View per module in Accounts Controller 1500. Internal Clients 1430 and External Clients 1440 may invoke modules 1501 through 1508 comprising Accounts Controller 1500. We focus primarily on these modules. The definitions of Models 1510 can be derived from the data structure defined by Accounts DB 402, and the details of Views 1520 are implementation details which can vary without changing the overall utility or nature of the System described herein.

In some embodiments, Signup Module 1501 provide an interface which can provision a new User 201 of Platform 230. Login Module 1502 can subsequently present an interface which allows a Client Device to, on behalf of such a User, obtain access to the Platform, creating a Login Session which can be used by said Client Device to access other Platform Services such as other applications in Management Interface 236, API Services 232, and so forth. Login Process 1502 can generate a Login Cookie which is stored within Web Browser 216 or Mobile Browser 218, and can be automatically sent to all such Platform Services. Note that in a security-focused embodiment of the system, session management would likely be implemented differently, as described under Accounts Application 1400 in FIG. 14.

In some embodiments, Change Password Module 1503 can present an interface which allows an authenticated Client Device to change the password of the authenticated User via Login Module 1502. In security-minded implementations, policies would be established requiring each frequent usage of Change Password Module 1503 on a regular basis, such as every 60 days, with the details being dependent on the business constraints involved. In addition, password security requirements could be implemented to ensure that User passwords are not easily guessable by a potential Attacker.

In some embodiments User Management Module 1504 can present a user interface which can configure access such that more than one User may manage a given Service Level Agreement configuration, such that the Management Interface may allow the responsibility of managing a Service Level Agreement configuration to be shared between multiple users.

In some embodiments, Billing Management Module 1505 can present a user interface which can allow a Client Device to: manage billing details, such as credit card information, used for monthly automated billing; upgrade or downgrade the authenticated user's subscription to Platform 230, modifying their monthly fee as well as their level of functionality; or cancel the authenticated user's service at the end of the current billing period.

In some embodiments, Profile Management Process 1506 can present a user interface allowing a Client Device to manage important personal and company information on behalf of an authenticated user, including: personal name and contact information; business name and contact information; and so forth.

In some embodiments, Session Info Process 1508 can allow peer applications and services, such as API Services 232 or SLA Configuration App 1420 to (a) verify that a session token is valid, and (b) retrieve the details associated with said session, including information about the authenticated user.

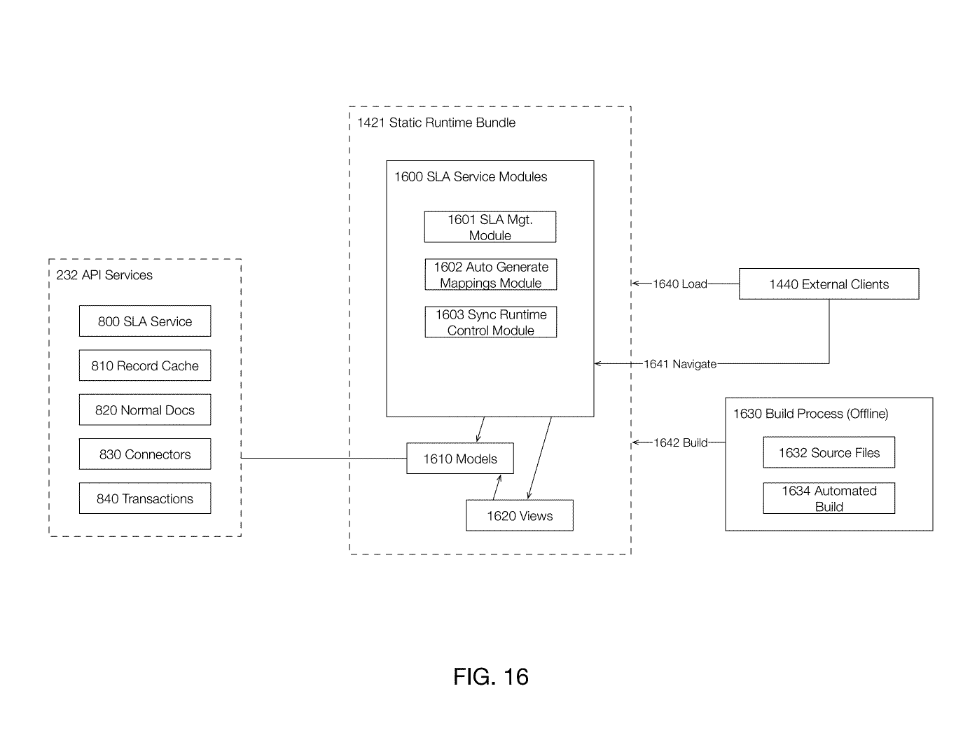

FIG. 16 shows the primary components of Static Runtime Bundle 1421 in accordance with some embodiments. The Static Runtime Bundle 1421 can be the sole component of SLA Configuration App 1420. 1420 and its runtime environment 1421 a Client Device to, on behalf of the authenticated user, define an SLA configuration such as 239, which can parameterize Virtual Data Bus 238 such that it may carry out automated data synchronization operations according to the User's specification. The Runtime Bundle 1421 can be structured as dictated by the MVC pattern. There can be a single controller, SLA Service Modules 1600. Models 1610 can access API Services 232 as the data storage tier, rather than a traditional database. The entire Runtime 1421 can be loaded by an External Client 1440, and executed in a Web Browser 216 or Mobile Browser 218.

In some embodiments, External Clients 1440 can access Static Runtime Bundle 1421 via Load Request 1640, downloading Bundle 1421 and executing it within a Web or Mobile Browser. The External Clients can navigate the application via Navigate Request 1641, causing the Client Device in question to display different pages of the application, executing the different modules shown here, and so forth. In some embodiments Build Module 1630 can construct a new Runtime Bundle 1421 from Source Files 1632 including source code. A developer can execute Automated Build 1634 manually, which can replace Static Runtime Bundle 1421 with the newly built version of said Bundle such that future access to the application will use the updated bundle.

In some embodiments, SLA Service Modules 1600 can include several modules which utilize Models 1610 to access API Services 232, delegating display behaviors to Views 1620.

In some embodiments, SLA Management Module 1601 can present a user interface which may configure a Service Level Agreement configuration such as 239, which can govern the activities of Virtual Data Bus 238. Module 1601 can manage Service Level Agreement Store module 404, configuring Agents 510, Mappings 512, and Workflows 514, which have been previously described.

In some embodiments, Auto Generate Mappings Module 1602 can automatically generate a Mapping 513 given the details of the Schema Document produced by each Connector Implementation from 1210 which has previously been configured in the SLA configuration. Module 1602 analyzes said Schema Documents and determines “common fields” which exist on data objects of the same logical type (such as “contact” or “company”) across different configured systems. For example, Module 1602 might notice that Connector A 832 exposes an object called “company” with a field called “name”, while Connector B 833 exposes an object called “business entity” with a field called “business name”. Since Connector A's “company” object and Connector B's “business entity” object both refer to the same type of real world entity (i.e., a business), and because the “name” and “business name” fields refer to the same data point on such entities (i.e., the name of the business), Process 1602 could automatically associate these fields in a Data Mapping 513 such that Virtual Data Bus 238 would automatically synchronize data between these fields. Depending on specific implementation constraints, the details of Module 1602 may differ with each embodiment of the System. For example, in a safety-focused embodiment, one might choose a conservative process which only combines fields with names which exactly match each other. In an ease-of-use focused embodiment, one might choose a more aggressive process which can use soft matching or other means to determine which fields are most likely to be combined by the User. Either way, Module 1602 greatly simplifies the configuration process.

In some embodiments, Sync Runtime Control Module 1603 can present a user interface allowing a Service Level Agreement configuration such as 239 to be enabled or disabled after it has been configured utilizing Modules 1601 and 1602. Once a Service Level Agreement configuration (SLA configuration) is enabled, Virtual Data Bus 238 is responsible for automatically synchronizing data in order to honor said SLA configuration. If the SLA configuration is later disabled by Module 1603, Virtual Data Bus 238 will stop synchronizing data automatically.

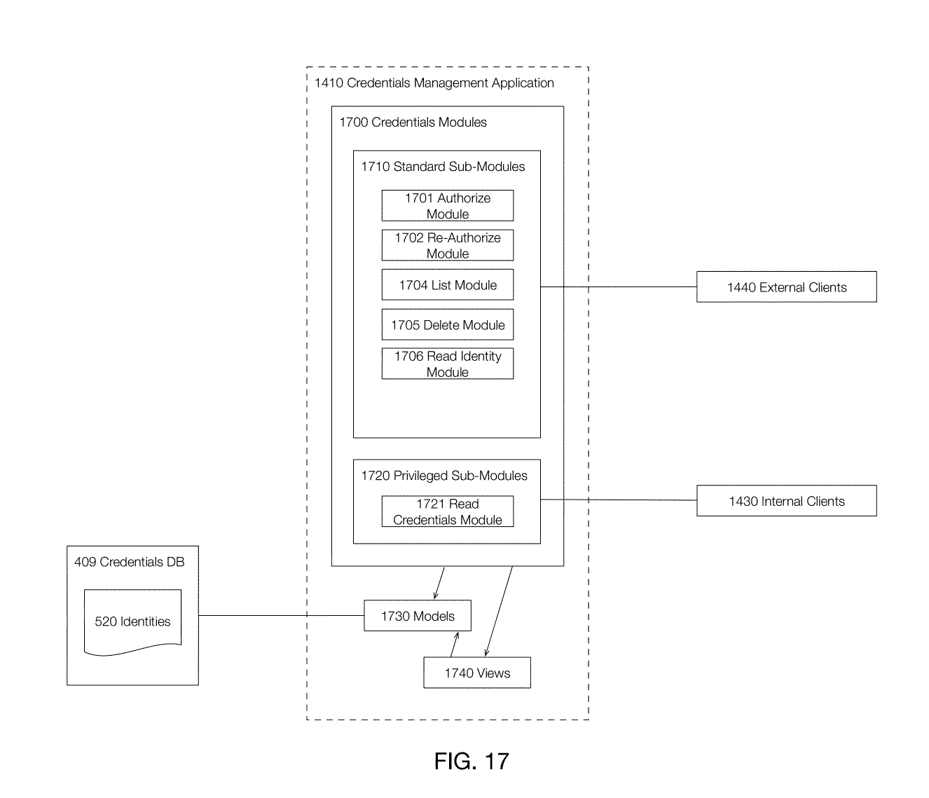

FIG. 17 provides a visual breakdown of Credentials Management Application 1410 in accordance with some embodiments. The Credentials Management Application 1410 can be responsible for collecting, validating, and storing User Credentials used by Connector Implementations 1210 such that Virtual Data Bus 238 may authenticate with Third Party Systems automatically. Application 1410 is an MVC application where Models 1730 access collection Identities 520 of Credentials DB 409 and Views 1740 present a User Interface whereby said User Credentials may be managed. Credentials Modules 1700 is broken into two sets of sub-modules: Standard Sub-Modules 1710, which are accessible by External Clients 1440 and Privileged Sub-Modules 1720, which are only accessible by Internal Clients 1430.

In some embodiments, Standard Sub-Modules 1710 can allow External Clients 1440 to manage Credentials which may be used by Connector Implementations 1210 in order to authenticate with Third Party Systems.

In some embodiments, the Authorize Module 1701 can be invoked via a redirect from Configuration Application 1420, receiving a System Reference which indicates a particular Third Party System from 240, as required by a given Connector Implementation from 1210, as well as a Redirect URI which will be invoked once 1701 is complete. When invoked, Module 1701 can determine what type of Authorization Flow is required by said Third Party System. Module 1701 can then initiates said Flow, which can include: (i) gathering Credentials from the Client Device on behalf of the authenticated user, and initiating a Remote Procedure Call in the Third Party System in order validate said Credentials; (ii) redirecting the Client Device to an authorization endpoint provided by the Third Party System, where said Client Device can ask the User to authorize the Calling Application (which is Application 1410 in this case) such that it may Remote Procedure Calls automatically in the future, and after such authorization, redirecting said Client Device back to said Application with an Authorization Code which can allow such future access; and (iii) other authorization methods which may be specific to the Third Party System.

In some embodiments, once Module 1701 obtains access to the Third Party System via said Authorization Flow, the validated Credentials are encrypted asymmetrically using a Public Key, and saved a new Identity document in 520 along with identifying metadata information such as the username from the Third Party System, such that the Client Device may present these details to the authenticated user for identification purposes in the future. In addition, 1701 can generate a unique Access Token which must be provided in order to access the saved Credentials in the future via Privileged Module 1721. Note that using Public Key encryption means that Application 1410 may encrypt Credentials but may not decrypt them. This is a useful security feature in any embodiment of the system, though it's reasonable to assume that a security-focused embodiment might take this even further, perhaps combining Public Key encryption with another encryption process in order to further decrease the likelihood of unprivileged actors accessing said Credentials. After the collected Credentials are encrypted and stored, 1701 can redirect the user to the Redirect URI received as input, specifying the unique Document ID and Access Token of the created Document in 520 as request parameters. Of course, in embodiments of the System which don't use HTTP as the central protocol, this flow will vary in order to accommodate the protocol being used.

In some embodiments, Re-Authorize Process 1702 can be roughly the same as Authorize Process 1701, except that after a successful Authorization Flow involving a Third Party System, 1702 will update a Document in Identities 520, rather than creating a new one. That is, 1702 allows previously stored credentials to be updated in case they have changed.

In some embodiments, List Module 1704 can display a given User's authorized Credentials, allowing the User to see which Third Party Systems have been authorized, and with which respective Identities.

In some embodiments, Delete Module 1705 can receive as input a preexisting set of stored Credentials (i.e., created by Module 1701). When invoked, Module 1705 can delete said Credentials from Identities 520 such that they can no longer be accessed or utilized by any part of Platform 230, whether to access the Third Party System in question, or for any other purpose.

In some embodiments, Read Identity Module 1706 can read profile details (but not encrypted Credentials) from Identities 520, allowing for retrieval of profile details about a previously authorized set of Credentials, such as first name, last name, email address, and other values which may be useful for display purposes.

In some embodiments, Privileged Sub-Modules 1720 allow Internal Clients 1430 to access encrypted User Credentials for use with Third Party Systems via Connector Implementations 1210. Read Credentials Module 1721 can receive as input a unique Document ID from Identities 520, as well as the unique Access Token associated with said Document ID. When invoked, Module 1721 can search for an Identity such as 521 with the given Document ID, and accessible with the given Access Token. If such an Identity is found, Module 1721 can generate output including the encrypted Credentials which were saved with said Identity during Modules 1701 or 1702. Note that since the Credentials are still public-key encrypted on output, even calling code will not be able to read the credentials, unless it is in possession of the Private Key which corresponds with the Public Key used to encrypt the credentials by 1701.

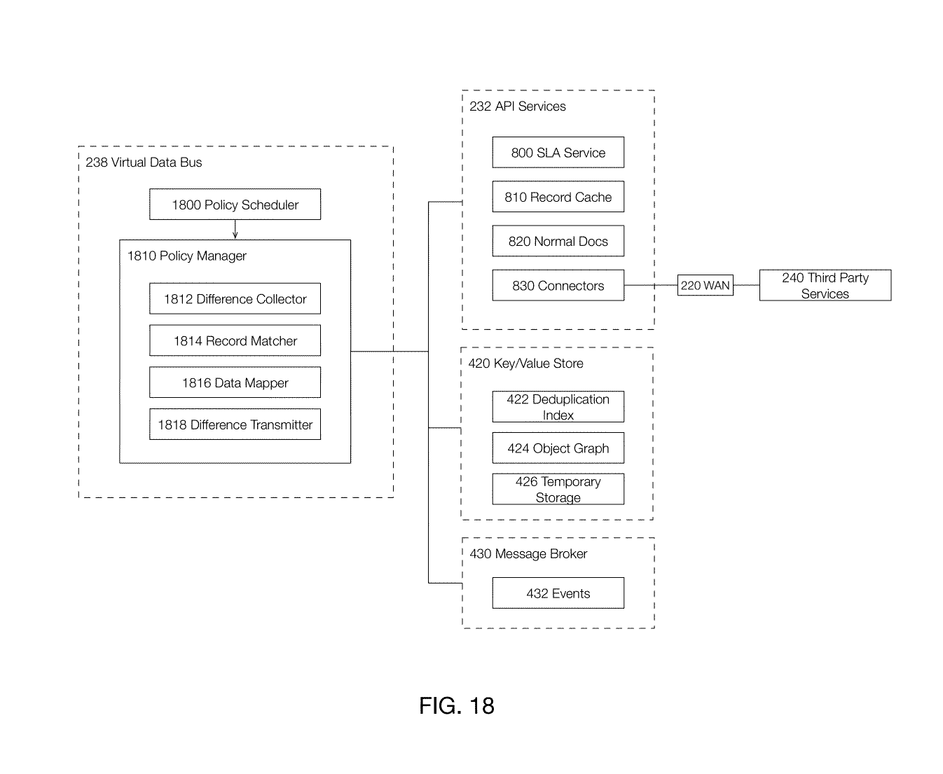

FIG. 18 illustrates the Virtual Data Bus 238 in accordance with some embodiments. The Virtual Data Bus 238 responsible for synchronizing data on an automated, continuous basis as specified by a Service Level Agreement configuration 239.

In some embodiments, Policy Scheduler 1801 can monitor all configured Service Level Agreement configurations such as 239, invoking Policy Manager 1810 as necessary in order to maintain compliance with the synchronization-related policies included in said Agreements. Policy Manager 1801 can be implemented as a series of modules 1812 through 1818 which are responsible for undertaking operations in order to enforce said compliance.

In some embodiments, Difference Collector 1812 may be responsible for gathering modified data objects from all Third Party Systems included in said SLA configuration, for detecting field-level differences in said data objects, for sending said transmitting said Records to Cache Preparation Module 1006, and for adding said data objects to Modified Set 720. Once all modifications from Third Party Services have been collected in such a manner, and Difference Collector 1812 can invoke Record Matcher 1814.

In some embodiments, Record Matcher 1814 can be a software module responsible for: transmitting all modified data objects to Cache Commit Module 1008; indexing said data objects for deduplication, and finally, once all indexing is complete; matching each data object with one or more data objects from other third party systems which represent the same real world entity; and finally, for invoking Data Mapper 1816.

In some embodiments, Data Mapper 1816 can be a software module responsible for synchronizing data between a set of matched data objects—that is, between a set of data objects which represent the same real world entity. After said synchronization is complete, Data Mapper 1816 can invoke Data Transmitter 518.

In some embodiments, Data Transmitter 518 can be a software module responsible for: calculating the differences between the abstract data objects resulting from Data Mapper 516 and the current state of the corresponding concrete data objects stored in their respective third party systems; for each one, determining whether a concrete data object needs to be created or update; and if so, for requesting such an operation via a Remote Procedure Call to the associated third party service.

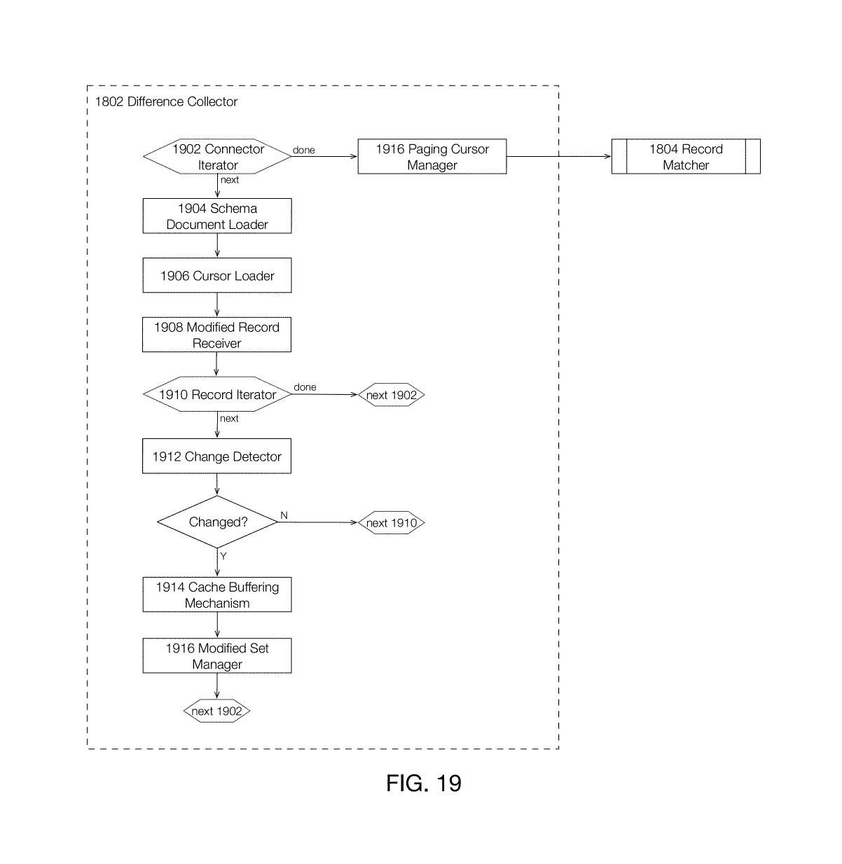

FIG. 19 illustrates the Difference Collector 1802 in accordance with some embodiments. The Difference Collector 1802 can be implemented as a software module which gathers modified data objects from third party systems for purposes of synchronization in accordance with Service Level Agreement configurations.

In some embodiments, Connector Iterator 1902 may be responsible for fetching each Agent from 510, that is, each Third Party System which is configured in the Service Level Agreement configuration being applied. Each of the following steps 1904 through 1910 can be completed once per each such Agent.

In some embodiments, Schema Document Loader 1904 can instruct Connector Proxy 1220 to interface with a Connector Implementation from 1210, calling upon Schema Module 1202 in order to fetch the Schema Document associated with the credentials associated with the Agent from 510 currently being iterated.

In some embodiments, Cursor Loader 1906 can fetch metadata from Agent 510 which can configure Modified Record Receiver 1908 such that it knows the time range in which it may need to receive modified data objects from each Connector Implementation from 1210 (as opposed to receiving all data objects in each such system, which may be far more time consuming). Then Modified Record Receiver 1908 can instruct each Third Party System configured by the Service Level Agreement configuration to transmit said data objects, upon which Receiver 1908 can pass them to Record Iterator 1910.

In some embodiments, Record Iterator 1910 can propagate each modified data object from a particular Third Party System to the following steps 1912 through 1916. That is, steps 1912 through 1916 can be invoked once per modified data object collected from each Third Party System which is referenced by the Service Level Agreement configuration, in sequence, ordered as shown in FIG. 19.

In some embodiments, Change Detector 1912 can detect field-level changes to a modified data object. That is, given a modified version of the data object as collected by Modified Record Receiver 1908, Change Detector 1912 can compare said data object against the Record Cache 406 via Diff Module 1004. If no differences are found, difference collection continues with the next modified data object at Record Iterator 1910.

In some embodiments, if differences to a modified data object are discovered by Diff Module 1004, Cache Buffering Mechanism 1914 can transmit such a changed data object to Cache Buffer Module 1006, such that the modifications can be captured, but not yet be recognized by Diff Module 1004. This can act as a safety mechanism, such that if the Difference Collector is for some reason interrupted after 1914 but before Modified Set Manager 1916, the System can guarantee that all changed data objects, including any which have already passed through Cache Buffering Mechanism 1914, but not Modified Set Manager 1916, will continue to trigger change detection in future Difference Collection invocations, such that they can still pass through 1916 eventually.

In some embodiments, Modified Set Manager 1916 can add the Record Reference associated with a changed data object to Modified Set 720, marking it for further synchronization by the remaining mechanisms in Difference Collector 1802. This can allow the changed data object's data to be temporarily discarded, since it is already stored in cache and marked for further synchronization; in an embodiment as a computer software system, this important property would allow valuable resources to be freed, such as RAM, preventing any one invocation of Policy Manager 1810 from consuming so many resources that other invocations become impossible or performance-degraded, which can lead to SLA configuration violations.

In some embodiments, after all modified data objects have been propagated by Record Iterator 1910, and all connectors have been propagated by Connector Iterator 1902, Difference Collection can complete with Paging Cursor Manager 1916, which can store final paging cursors gathered by Record Iterator 1910, such that future invocations of Difference Collector 1802 can receive modifications within a finite time range as described above. At this point, policy management can continue with Record Matcher 1804.

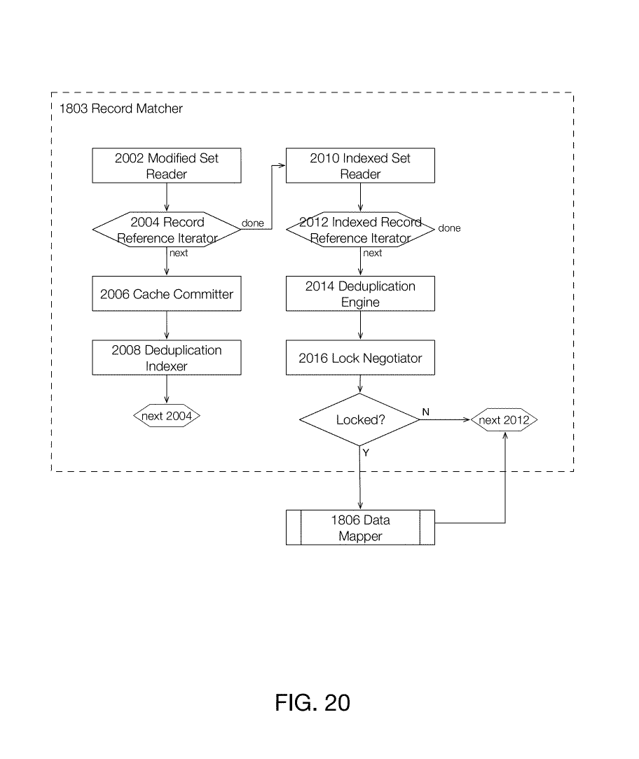

FIG. 20 illustrates the method steps implemented by the Record Matcher 1803 in accordance with some embodiments. The Record Matcher 1803 can identify data objects existing in separate third party systems but representing the same real-world entity, such as Customer Record 122 and Billing Account Record 132 in the example use case provided in FIG. 100, which exist in separate systems, but represent the same real-world customer.

In some embodiments, Modified Set Reader 2002 can access Modified Set 722 such that Record Reference Iterator 2004 may iterate its included Record References. Iterator 2004 propagates each Reference, such that each reference may trigger mechanisms 2006 through 2008, in order, as shown in the figure.

In some embodiments, Cache Committer 2006 can invoke Cache Commit Module 1008, such that for a given modified Record Reference, all previously buffered modifications to the referenced data object can be merged with the recognized cache data, such that all future cache operations for said data object will be aware of said modifications.

In some embodiments, the output from Cache Commit Module 1008 for a particular data object can be the fully recognized data object data including all modifications, which can be passed through Deduplication Indexer 2008, which can update Dedupe Index 422 such that said data object can be identified as representing a particular real-world entity in the future. In the embodiment pictured by FIG. 20, Indexer 2008 can add the Record Reference associated with said data object to Indexed Set 724, marking it for further synchronization. This has the same similar implications and benefits as with respect to Modified Set Manager 1916 above.

As with Modified Set Reader 2002, Modified Set 720, and Record Reference Iterator 2004, Indexed Set Reader 2010 can access Indexed Set 722, allowing Indexed Record Reference Iterator 2012 to propagate each indexed data object reference to mechanisms 2014 through 2016 in accordance with some embodiments.

In some embodiments, Deduplication Engine 2014 can, given a particular indexed Record Reference, locate references to all data objects existing in all third party systems referenced by the SLA configuration being applied which represent the same real-world entity as the referenced indexed data object. The resulting list of data object references can be termed the Dedupe Set.

In some embodiments, such as a computer software system utilizing concurrency in order to deliver a highly performant Virtual Data Bus, Lock Negotiator 2016 can attempt to exclusively lock the Dedupe Set, such that no other concurrent instance of Record Matcher 1803 may proceed with the same Dedupe Set, which could happen, for example, as a result of invoking Deduplication Engine 2014 with another Record Reference included in said Set—i.e., if more than one data object referenced by said Set has changed. When such a lock is obtained, policy management can continue with Data Mapper 1806 acting on the Dedupe Set. Regardless of whether the lock is obtained, Record Matcher 1803 can continue with the next indexed data object at Iterator 2012.

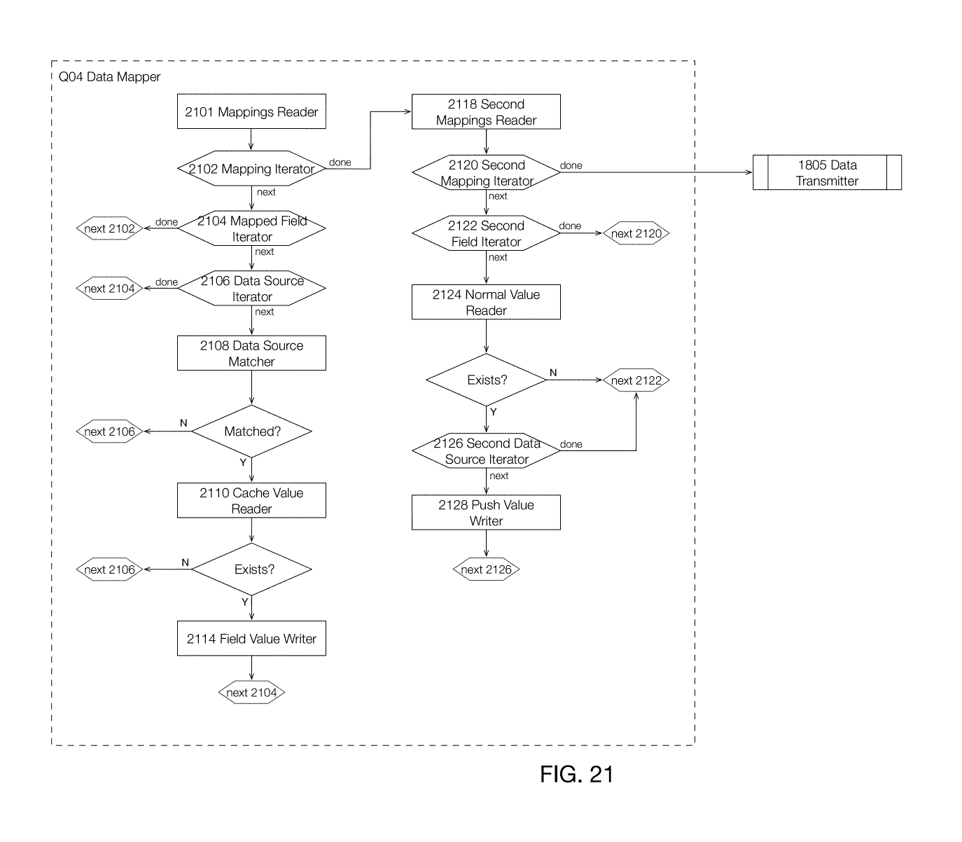

FIG. 21 shows the method steps implemented by the Data Mapper 1804 in accordance with some embodiments. The Data Mapper 1804 can synchronize data between data objects which are part of a single Dedupe Set, meaning that they represent the same real-world entity as described above, in accordance with some embodiments. Mappings Reader 2101 can access the data mappings included in the Service Level Agreement configuration being applied, such that: Mapping Iterator 2102 may propagate each such mapping to mechanisms 2104 through 2114; for a particular mapping, Mapped Field Iterator 2104 can propagate each mapped field included in said mapping to mechanisms 2106 through 2114; and, for a particular mapped field, Data Source Iterator may pass each data source included in said mapped field to mechanisms 2108 through 2114 in explicit order as described by the Service Level Agreement configuration. In other words, each data source included in each mapped field included in each mapping included in the current SLA configuration can be passed through mechanisms 2108 through 2114 exactly once, in certain embodiments.

In some embodiments, Data Source Matcher 2108 can match a particular mapped field data source to one or more data object(s) in the Dedupe Set, meaning that said data object(s) are referenced by said data source. If such a match does not occur, the data source can be bypassed, and data mapping can continue with the next data source (if any) at Iterator 2106.

If a match does occur in Data Source Matcher 2108, then Cache Value Reader 2110 can in some embodiments read the cached value of the field referenced by the matched data source. If such a value does not exist, the data source can be discarded as above, with data mapping continuing with the next data source (if any) at Iterator 2106.

If a value does exist in Cache Value Reader 2110, then Field Value Writer 2114 can in some embodiments write the cached value to the Normal Doc from 518 associated with this particular Dedupe Set, which essentially selects this particular field value from this particular cached data object as the canonical value for this mapped field across all data objects in said Dedupe Set. Due to the explicit order of data sources propagated from Iterator 2106, this field value is guaranteed to be the one specified in the Service Level Agreement configuration as the canonical value in case more than data object includes a value matching the current data source.

In some embodiments, the Second Mappings Reader 2119 again access the data mappings included in the Service Level Agreement configuration being applied, such that Iterators 2120 and 2122, which function similarly to Iterators 2102 and 2104, may propagate each mapped field of each mapping to mechanisms 2124 through 2128.

In some embodiments, Normal Value Reader 2124 can read the value of a mapped field from the Normal Doc from 518 associated with the Dedupe Set. If such a value does not exist, Data Mapping can continue with the next mapped field at Second Field Iterator 2122. If however such a value is found, Second Data Source Iterator 2126 can propagate each data source included in said mapped field to mechanism 2128.

In some embodiments, Push Value Writer 2128 can store this normal field value in Push Values 724, continuing data mapping with the next data source included in the current mapped field at Second Mapping Iterator 2126. Once all such data sources have been propagated by Iterator 2126, data mapping can continue with the next mapped field at Second Field Iterator 2122. Finally after all such fields are propagated, policy management can continue with Data Transmitter 1805.

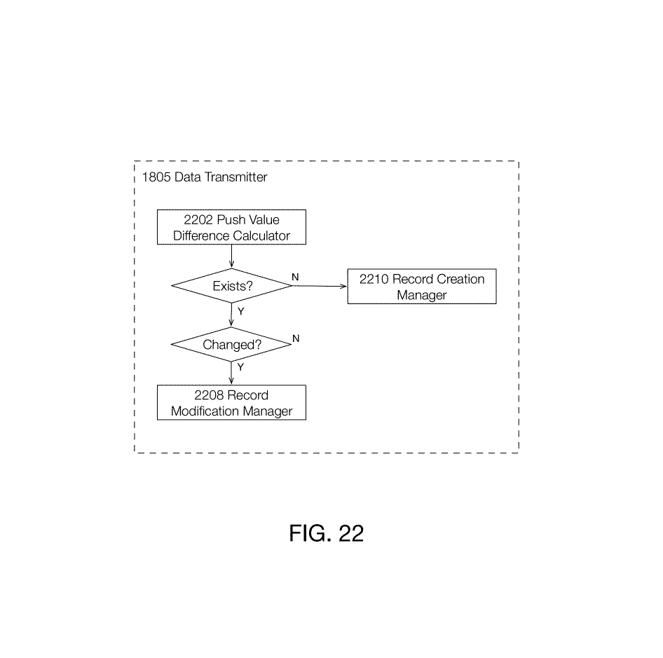

FIG. 22 shows the method steps implemented by Data Transmitter 1805 in accordance with some embodiments. The Data Transmitter 1805 can be responsible for transmitting data object modifications in order to keep data objects in third party systems synchronized with the canonical values identified by Data Mapper 1804.

In some embodiments, Push Value Difference Calculator 2202 can determine the differences between any canonical values written to Push Values 724 by Push Value Writer 2128, and current cache values for the associated data object, which represent the most recent version of the associated data object in the third party system as collected by Difference Collector 1802. If no such cache data object exists, then such a third party data object does not exist by implication, and so Record Creation Manager 2210 can create said data object via Connector Proxy 1220 using said push values, which are individual field values comprising said data object. If however such a cache data object does exist, and the push values represent a change to said data object, then data object Modification Manager 2208 can transmit the modified fields to the relevant third party system via Connector Proxy 1220.

Embodiments of the disclosed subject matter processes data objects of external systems. Data items can include, for example, a file, text, a list, a folder, or any electronic record that is capable of carrying information.

The above-described techniques can be implemented in digital electronic circuitry, or in computer hardware, firmware, software, or in combinations of them. The implementation can be as a computer program product, e.g., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Processors suitable for the execution of a computer program include, by way of example, both general and special purpose microprocessors, digital signal processors, and any one or more processors of any kind of digital computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. A computer can be operatively coupled to external equipment, for example factory automation or logistics equipment, or to a communications network, for example a factory automation or logistics network, in order to receive instructions and/or data from the equipment or network and/or to transfer instructions and/or data to the equipment or network. Computer-readable storage devices suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

In some embodiments, the client device 210 can include a user equipment in a wireless communications network. The client device 210 communicates with one or more networks and with wired communication networks. The client device 210 can be a cellular phone having phonetic communication capabilities. The client device 210 can also be a smart phone providing services such as word processing, web browsing, gaming, e-book capabilities, an operating system, and a full keyboard.

In some embodiments, the client device 210 can be a tablet computer providing network access and most of the services provided by a smart phone. The client device 210 operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment 100 can also keep global positioning coordinates, profile information, or other location information.

In some embodiments, the client device 210 also includes any platforms capable of computations and communication. Non-limiting examples can include televisions (TVs), video projectors, set-top boxes or set-top units, digital video data objecters (DVR), computers, netbooks, laptops, and any other audio/visual equipment with computation capabilities. The client device 210 can have a memory such as a computer readable medium, flash memory, a magnetic disk drive, an optical drive, a programmable read-only memory (PROM), and/or a read-only memory (ROM). The client device 210 is configured with one or more processors that process instructions and run software that may be stored in memory. The processor also communicates with the memory and interfaces to communicate with other devices. The processor can be any applicable processor such as a system-on-a-chip that combines a CPU, an application processor, and flash memory. The client device 210 can also provide a variety of user interfaces such as a keyboard, a touch screen, a trackball, a touch pad, and/or a mouse. The client device 210 may also include speakers and a display device in some embodiments.

In some embodiments, the Platform 230 can be implemented in one or more servers in one or more data centers. A server can operate using an operating system (OS) software. The OS software can be based on a software kernel and runs specific applications in the server such as monitoring tasks and providing protocol stacks. The OS software allows host server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources are dynamically deployed to meet the requirements in some embodiments.

In some embodiments, the server's software can be divided into a series of task modules that perform specific functions. These task modules communicate with each other as needed to share control and data information throughout the server. A task module can be a software that is operable to perform a specific function related to system control or session processing.

In some embodiments, the server can reside in a data center and forms a node in a cloud computing infrastructure. The server can provide services on demand. A module hosting a client can migrate from one server to another server seamlessly, without causing any program faults or system breakdown. The server on the cloud can be managed using a management system.

In some embodiments, one or more modules in the Platform 230 can be implemented in software. In some embodiments, the software for implementing a process or a database includes a high level procedural or an object-orientated language such as C, C++, C#, Java, or Perl. The software may also be implemented in assembly language if desired. The language can be a compiled or an interpreted language. In some embodiments, the software is stored on a storage medium or device such as read-only memory (ROM), programmable-read-only memory (PROM), electrically erasable programmable-read-only memory (EEPROM), flash memory, a magnetic disk that is readable by a general or special purpose-processing unit to perform the processes described in this document, or any other memory or combination of memories. The processors that operate the modules can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the one or more of the Platform 230 can be implemented in hardware using an ASIC (application-specific integrated circuit), PLA (programmable logic array), DSP (digital signal processor), FPGA (field programmable gate array), or other integrated circuit. In some embodiments, two or more modules can be implemented on the same integrated circuit, such as ASIC, PLA, DSP, or FPGA, thereby forming a system on chip. Subroutines can refer to portions of the computer program and/or the processor/special circuitry that implement one or more functions.

In some embodiments, packet processing implemented in a server can include any processing determined by the context. For example, packet processing may involve high-level data link control (HDLC) framing, header compression, and/or encryption.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A system configured to synchronize data objects in a plurality of external systems, the system comprising:
one or more interfaces configured to communicate with a client device;
at least one server, in communication with the one or more interfaces, configured to:
receive a request from a client device over via the one or more interfaces, wherein the request includes an instruction to configure a service level agreement (SLA) configuration, wherein the SLA configuration is configured to specify a policy for automatically synchronizing data between two or more external systems;
receive a plurality of data objects from the plurality of external systems in compliance with the SLA configuration;
deduplicate the plurality of data objects to determine a set of deduplicated data objects from the plurality of data objects in compliance with the SLA configuration;
determine one or more differences between the set of deduplicated data objects; and
synchronize information between the set of deduplicated data objects by writing the one or more differences into the plurality of data objects stored in the plurality of external systems.

2. The system of claim 1, wherein the SLA configuration comprises a description of external systems between which to synchronize data objects.

3. The system of claim 2, wherein the SLA configuration further comprises a description of data objects, maintained by external systems satisfying the description of external systems, that are subject to synchronization.

4. The system of claim 2, wherein the SLA configuration further comprises a description of fields, in data objects satisfying the description of data objects, that are subject to synchronization.

5. The system of claim 1, wherein the external request comprises a stream of Hypertext Transfer Protocol (HTTP) requests.

6. The system of claim 1, further comprising a load balancer module that is configured to receive the external request and select a functioning server, in the system, for serving the external request.

7. The system of claim 1, wherein the at least one server is further configured to automatically synchronize information between the set of deduplicated data objects on a periodic basis.

8. The system of claim 1, wherein the at least one server comprises a single data center.

9. The system of claim 1, wherein the plurality of external systems comprises a CRM system, a marketing automation system, and/or a finance system.

10. A computerized method of synchronizing data objects in a plurality of external systems, the method comprising:
receiving, by a system comprising at least one server, a request from a client device over via one or more interfaces, wherein the request includes an instruction to configure a service level agreement (SLA) configuration, wherein the SLA configuration is configured to specify a policy for automatically synchronizing data between two or more external systems;
receiving, by the system, a plurality of data objects from the plurality of external systems in compliance with the SLA configuration;
deduplicating, by the system, the plurality of data objects to determine a set of deduplicated data objects from the plurality of data objects in compliance with the SLA configuration;
determining, by the system, one or more differences between the set of deduplicated data objects; and
synchronizing, by the system, information between the set of deduplicated data objects by writing the one or more differences into the plurality of data objects stored in the plurality of external systems.

11. The method of claim 10, wherein the SLA configuration comprises a description of external systems between which to synchronize data objects.

12. The method of claim 11, wherein the SLA configuration further comprises a description of data objects, maintained by external systems satisfying the description of external systems, that are subject to synchronization.

13. The method of claim 12, wherein the SLA configuration further comprises a description of fields, in data objects satisfying the description of data objects, that are subject to synchronization.

14. The method of claim 10, wherein the external request comprises a stream of Hypertext Transfer Protocol (HTTP) requests.

15. The method of claim 10, further comprising automatically synchronizing information between the set of deduplicated data objects on a periodic basis.

16. The method of claim 10, wherein the plurality of external systems comprises a CRM system, a marketing automation system, and/or a finance system.

17. A non-transitory computer readable medium having executable instructions operable to cause a data processing apparatus to:
receive a request from a client device over via one or more interfaces, wherein the request includes an instruction to configure a service level agreement (SLA) configuration, wherein the SLA configuration is configured to specify a policy for automatically synchronizing data between two or more external systems;
receive a plurality of data objects from a plurality of external systems in compliance with the SLA configuration;
deduplicate the plurality of data objects to determine a set of deduplicated data objects from the plurality of data objects in compliance with the SLA configuration;
determine one or more differences between the set of deduplicated data objects; and
synchronize information between the set of deduplicated data objects by writing the one or more differences into the plurality of data objects stored in the plurality of external systems.

18. The non-transitory computer readable medium of claim 17, wherein the SLA configuration comprises a description of external systems between which to synchronize data objects.

19. The non-transitory computer readable medium of claim 18, wherein the SLA configuration further comprises a description of data objects, maintained by external systems satisfying the description of external systems, that are subject to synchronization.

20. The non-transitory computer readable medium of claim 19, wherein the SLA configuration further comprises a description of fields, in data objects satisfying the description of data objects, that are subject to synchronization.
